(19) United States
(12) Patent Application Publication
(10) Pub. No.: US 2019/0095400 A1
(43) Pub. Date: Mar. 28, 2019

(54) ANALYTIC SYSTEM TO INCREMENTALLY UPDATE A SUPPORT VECTOR DATA DESCRIPTION FOR OUTLIER IDENTIFICATION

(71) Applicant: SAS Institute Inc., Carly, NC (US)

(72) Inventors: Hansi Jiang, Raleigh, NC (US); Wenhao Hu, Raleigh, NC (US); Haoyu Wang, Raleigh, NC (US); Deovrat Vijay Kakde, Cary, NC (US); Arin Chaudhuri, Raleigh, NC (US)

(21) Appl. No.: 16/030,142

(22) Filed: Jul. 9, 2018

Related U.S. Application Data
(60) Provisional application No. 62/564,453, filed on Sep. 28, 2017.

(51) Int. Cl. G06F 17/16; G06N 99/00

(52) U.S. Cl. CPC G06F 17/16; G06N 99/005

(57) ABSTRACT

A Gaussian similarity matrix is computed between observation vectors. An inverse Gaussian similarity matrix is computed from the Gaussian similarity matrix. A row sum vector is computed that includes a row sum value computed from each row of the inverse Gaussian similarity matrix. (a) A new observation vector is selected. (b) An acceptance value is computed for the new observation vector using the set of boundary support vectors, the row sum vector, and the new observation vector. (c) (a) and (b) are repeated when the computed acceptance value is less than or equal to zero. (d) An incremental vector is computed from the inverse Gaussian similarity matrix and the new observation vector when the computed acceptance value is greater than zero. (e) the selected new observation vector is output as an outlier observation vector when a maximum value of the incremental vector is less than a first predefined tolerance value.

### CROSS-REFERENCE TO RELATED APPLICATIONS

The present application claims the benefit of 35 U.S.C. § 119(e) to U.S. Provisional Patent Application No. 62/564,453 filed on Sep. 28, 2017, the entire contents of which are hereby incorporated by reference.

### BACKGROUND

A great deal of effort is expended in fault and state shift detection in industrial machines through monitoring of data sensors. Successful fault diagnosis reduces a cost of maintenance and improves both worker and machine efficiency. In machine learning, fault diagnosis can be viewed as an outlier detection problem. Support vector data description (SVDD) is a machine-learning technique used for single class classification and outlier or anomaly detection. The SVDD classifier partitions the space into an inlier region that consists of the region near training data, and an outlier region that consists of points away from the training data. Computation of an SVDD classifier typically uses a kernel function with the Gaussian kernel being a common choice for the kernel function. When dealing with online (streaming) or large quantities of data, existing SVDD computation methods must be rerun each iteration requiring significant computational resources and computing time that delays a responsiveness to fault and state shifts that may occur in industrial machines as just one example of application of the SVDD classifier.

### SUMMARY

In an example embodiment, a non-transitory computer-readable medium is provided having stored thereon computer-readable instructions that, when executed by a computing device, cause the computing device to iteratively update a support vector data description for outlier identification. A Gaussian similarity matrix is computed between a plurality of observation vectors. Each observation vector of the plurality of observation vectors includes a variable value for each variable of a plurality of variables. An inverse Gaussian similarity matrix is computed from the computed Gaussian similarity matrix. A row sum vector is computed that includes a row sum value computed from each row of the computed inverse Gaussian similarity matrix. A set of boundary support vectors is selected from the plurality of observation vectors. (a) A new observation vector is selected. (b) An acceptance value is computed for the selected new observation vector using the selected set of boundary support vectors, the computed row sum vector, and the new observation vector. (c) (a) and (b) are repeated when the computed acceptance value is less than or equal to zero. (d) An incremental vector is computed from the computed inverse Gaussian similarity matrix and the selected new observation vector when the computed acceptance value is greater than zero. (e) The selected new observation vector is output as an outlier observation vector when a maximum value of the computed incremental vector is less than a first predefined tolerance value.

In another example embodiment, a computing device is provided. The computing device includes, but is not limited to, a processor and a non-transitory computer-readable medium operably coupled to the processor. The computer-readable medium has instructions stored thereon that, when executed by the computing device, cause the computing device to iteratively update a support vector data description for outlier identification.

In yet another example embodiment, a method of iteratively updating a support vector data description for outlier identification is provided.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a support vector data description (SVDD) update device in accordance with an illustrative embodiment.

FIG. 2 depicts an SVDD result defining a normal data description in accordance with an illustrative embodiment.

FIG. 3 depicts an SVDD result defining a flexible data description using a Gaussian kernel function in accordance with an illustrative embodiment.

FIGS. 4A-4E depicts a flow diagram illustrating examples of operations performed by the SVDD update device of FIG. 1 in accordance with an illustrative embodiment.

FIG. 5 depicts a first sample dataset having a banana shape in accordance with an illustrative embodiment.

FIG. 6 depicts SVDD results using two different methods and the first sample dataset of FIG. 5 in accordance with an illustrative embodiment.

FIG. 7 depicts a second sample dataset having a star shape in accordance with an illustrative embodiment.

FIG. 8 depicts SVDD results using two different methods and the second sample dataset of FIG. 7 in accordance with an illustrative embodiment.

FIG. 9 depicts a third sample dataset having a two-doughnut shape in accordance with an illustrative embodiment.

FIG. 10 depicts SVDD results using two different methods and the third sample dataset of FIG. 9 in accordance with an illustrative embodiment.

FIG. 11 depicts SVDD results using two different methods and a fourth sample dataset in accordance with an illustrative embodiment.

FIG. 12 depicts a block diagram of a stream processing system in accordance with an illustrative embodiment.

FIG. 13 depicts a block diagram of an event stream processing (ESP) device of FIG. 12 in accordance with an illustrative embodiment.

FIG. 14 depicts a flow diagram illustrating examples of operations performed by the ESP device of FIG. 13 in accordance with an illustrative embodiment.

FIG. 15 depicts a block diagram of an ESP engine executing on the ESP device of FIG. 13 in accordance with an illustrative embodiment.

FIG. 16 depicts a block diagram of an event publishing device of an event publishing system of the stream processing system of FIG. 12 in accordance with an illustrative embodiment.

FIG. 17 depicts a flow diagram illustrating examples of operations performed by the event publishing device of FIG. 16 in accordance with an illustrative embodiment.

FIG. 18 depicts a block diagram of an event subscribing device of an event subscribing system of the stream processing system of FIG. 12 in accordance with an illustrative embodiment.

FIG. 19 depicts a flow diagram illustrating examples of operations performed by the event subscribing device of FIG. 18 in accordance with an illustrative embodiment.

FIG. 20 provides experimental results that compare a performance of the two different methods using four different datasets that include the fourth sample dataset in accordance with an illustrative embodiment.

FIG. 21 depicts an F-1 measure of the accuracy achieved for different training dataset sizes using two different methods and the fourth sample dataset in accordance with an illustrative embodiment.

FIG. 22 depicts the F-1 measure of the accuracy achieved for different training dataset sizes using two different methods and a fifth sample dataset in accordance with an illustrative embodiment.

FIG. 23 depicts the F-1 measure of the accuracy achieved for different training dataset sizes using two different methods and a sixth sample dataset in accordance with an illustrative embodiment.

FIG. 24 depicts the F-1 measure of the accuracy achieved for different training dataset sizes using two different methods and a seventh sample dataset in accordance with an illustrative embodiment.

### DETAILED DESCRIPTION

Support vector data description (SVDD), like other one-class classifiers, provides a geometric description of observed data. The SVDD classifier computes a distance to each point in the domain space that is a measure of a separation of that point from training data. During scoring, if an observation is found to be a large distance from the training data, it may be an anomaly, and the user may choose to generate an alert that a system or a device is not performing as expected or a detrimental event has occurred.

SVDD is used in domains where the majority of data belongs to a single class, or when one of the classes is significantly undersampled. An SVDD algorithm builds a flexible boundary around target class data that is characterized by observations designated as support vectors. Because no assumptions about a distribution of outliers is made, SVDD can describe the boundary of the target class without prior knowledge of the specific data distribution and can identify observations that fall outside the boundary as potential outliers. In the case of machine monitoring, normal working condition data for a machine is in abundance, whereas there is little data for a system failure. By using SVDD on the well-sampled target class, a boundary around the distribution of normal working data is defined, and used to identify outlier points where the machine is faulty. Traditional batch methods of SVDD pursue a global optimal solution to the SVDD problem that considers all available data points resulting in a low computational efficiency. Additionally, these methods are usually ineffective when handling streaming data because the entire algorithm must be rerun with each incoming data point. As a result, as more and more data points are streamed into these methods, the solution requires greater and greater computing time and memory usage.

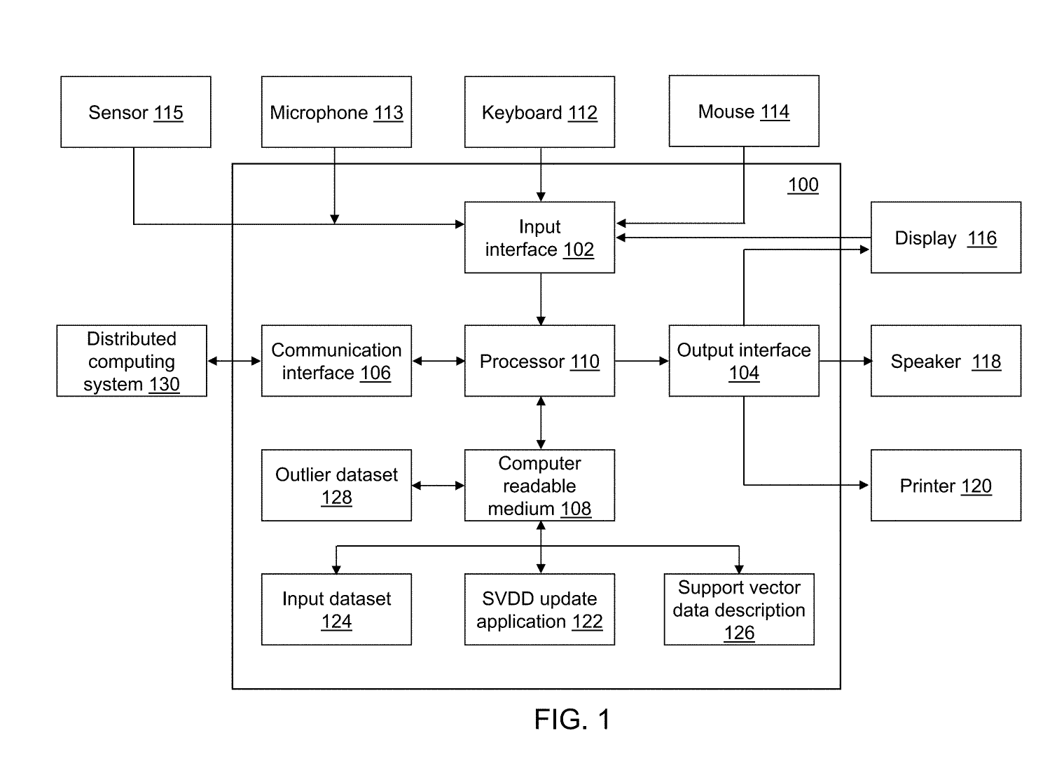

Referring to FIG. 1, a block diagram of an SVDD update device 100 is shown in accordance with an illustrative embodiment. SVDD update device 100 may include an input interface 102, an output interface 104, a communication interface 106, a non-transitory computer-readable medium 108, a processor 110, an SVDD update application 122, an input dataset 124, an SVDD 126, and an outlier dataset 128. Fewer, different, and/or additional components may be incorporated into SVDD update device 100.

Input interface 102 provides an interface for receiving information from the user or another device for entry into SVDD update device 100 as understood by those skilled in the art. Input interface 102 may interface with various input technologies including, but not limited to, a keyboard 112, a microphone 113, a mouse 114, a display 116, a track ball, a keypad, one or more buttons, etc. to allow the user to enter information into SVDD update device 100 or to make selections presented in a user interface displayed on display 116.

Input interface 102 may also interface with various input technologies such as a sensor 115. For example, sensor 115 may produce a sensor signal value referred to as a measurement data value representative of a measure of a physical quantity in an environment to which sensor 115 is associated and generate a corresponding measurement datum that may be associated with a time that the measurement datum is generated. The environment to which sensor 115 is associated for monitoring may include a power grid system, a telecommunications system, a fluid (oil, gas, water, etc.) pipeline, a transportation system, an industrial device, a medical device, an appliance, a vehicle, a computing device, etc. Example sensor types of sensor 115 include a pressure sensor, a temperature sensor, a position or location sensor, a velocity sensor, an acceleration sensor, a fluid flow rate sensor, a voltage sensor, a current sensor, a frequency sensor, a phase angle sensor, a data rate sensor, a humidity sensor, an acoustic sensor, a light sensor, a motion sensor, an electromagnetic field sensor, a force sensor, a torque sensor, a load sensor, a strain sensor, a chemical property sensor, a resistance sensor, a radiation sensor, an irradiance sensor, a proximity sensor, a distance sensor, a vibration sensor, etc. that may be mounted to various components used as part of the system.

The same interface may support both input interface 102 and output interface 104. For example, display 116 comprising a touch screen provides a mechanism for user input and for presentation of output to the user. SVDD update device 100 may have one or more input interfaces that use the same or a different input interface technology. The input interface technology further may be accessible by SVDD update device 100 through communication interface 106.

Output interface 104 provides an interface for outputting information for review by a user of SVDD update device 100 and/or for use by another application or device. For example, output interface 104 may interface with various output technologies including, but not limited to, display 116, a speaker 118, a printer 120, etc. SVDD update device 100 may have one or more output interfaces that use the same or a different output interface technology. The output interface technology further may be accessible by SVDD update device 100 through communication interface 106.

Communication interface 106 provides an interface for receiving and transmitting data between devices using various protocols, transmission technologies, and media as understood by those skilled in the art. Communication interface 106 may support communication using various transmission media that may be wired and/or wireless. SVDD update device 100 may have one or more communication interfaces that use the same or a different communication interface technology. For example, SVDD update device 100 may support communication using an Ethernet port, a Bluetooth antenna, a telephone jack, a USB port, etc. Data and messages may be transferred between SVDD update device 100 and another computing device of a distributed computing system 130 using communication interface 106.

Computer-readable medium 108 is an electronic holding place or storage for information so the information can be accessed by processor 110 as understood by those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. SVDD update device 100 may have one or more computer-readable media that use the same or a different memory media technology. For example, computer-readable medium 108 may include different types of computer-readable media that may be organized hierarchically to provide efficient access to the data stored therein as understood by a person of skill in the art. As an example, a cache may be implemented in a smaller, faster memory that stores copies of data from the most frequently/recently accessed main memory locations to reduce an access latency. SVDD update device 100 also may have one or more drives that support the loading of a memory media such as a CD, DVD, an external hard drive, etc. One or more external hard drives further may be connected to SVDD update device 100 using communication interface 106.

Processor 110 executes instructions as understood by those skilled in the art. The instructions may be carried out by a special purpose computer, logic circuits, or hardware circuits. Processor 110 may be implemented in hardware and/or firmware. Processor 110 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 110 operably couples with input interface 102, with output interface 104, with communication interface 106, and with computer-readable medium 108 to receive, to send, and to process information. Processor 110 may retrieve a set of instructions from a permanent memory device and copy the instructions in an executable form to a temporary memory device that is generally some form of RAM. SVDD update device 100 may include a plurality of processors that use the same or a different processing technology.

Some machine-learning approaches may be more efficiently and speedily executed and processed with machine-learning specific processors (e.g., not a generic central processing unit (CPU)). Such processors may also provide additional energy savings when compared to generic CPUs. For example, some of these processors can include a graphical processing unit, an application-specific integrated circuit, a field-programmable gate array, an artificial intelligence accelerator, a purpose-built chip architecture for machine learning, and/or some other machine-learning specific processor that implements a machine learning approach using semiconductor (e.g., silicon, gallium arsenide) devices. These processors may also be employed in heterogeneous computing architectures with a number of and a variety of different types of cores, engines, nodes, and/or layers to achieve additional various energy efficiencies, processing speed improvements, data communication speed improvements, and/or data efficiency targets and improvements throughout various parts of the system.

SVDD update application 122 performs operations associated with computing and updating SVDD 126 and classifying data stored in input dataset 124 to determine when an observation vector in input dataset 124 is an outlier or otherwise an anomalous vector of data that may be stored in an outlier dataset 128 to support various data analysis functions as well as provide alert/messaging related to monitored data. Outlier dataset 128 may include anomalies as part of process control, for example, of a manufacturing process, for machine condition monitoring, for example, of an electro-cardiogram device, for image classification, for intrusion detection, for fraud detection, etc. SVDD update application 122 can be used to identify anomalies that occur based on the data as or shortly after the data is generated. Some or all of the operations described herein may be embodied in SVDD update application 122. The operations may be implemented using hardware, firmware, software, or any combination of these methods.

Referring to the example embodiment of FIG. 1, SVDD update application 122 is implemented in software (comprised of computer-readable and/or computer-executable instructions) stored in computer-readable medium 108 and accessible by processor 110 for execution of the instructions that embody the operations of SVDD update application 122. SVDD update application 122 may be written using one or more programming languages, assembly languages, scripting languages, etc. SVDD update application 122 may be integrated with other analytic tools. As an example, SVDD update application 122 may be part of an integrated data analytics software application and/or software architecture such as that offered by SAS Institute Inc. of Cary, N.C., USA. For example, SVDD update application 122 may be implemented using or integrated with one or more SAS software tools such as SAS® Enterprise Miner™, Base SAS, SAS/STATO, SAS® High Performance Analytics Server, SAS® LASR™, SAS® In-Database Products, SAS® Scalable Performance Data Engine, SAS/ORO, SAS/ETSO, SAS® Inventory Optimization, SAS® Inventory Optimization Workbench, SAS® Visual Analytics, SAS® Viya™ SAS In-Memory Statistics for Hadoop®, SAS® Forecast Server, SAS® Event Stream Processing, all of which are developed and provided by SAS Institute Inc. of Cary, N.C., USA. Data mining is applicable in a wide variety of industries. For illustration, SVDD update application 122 may be executed by a procedure PROC SVDD implemented as part of SAS® Viya™.

SVDD update application 122 may be integrated with other system processing tools to automatically process data generated as part of operation of an enterprise, device, system, facility, etc., to update SVDD 126, to identify any outliers in new data, to monitor changes in the data, and to provide a warning or alert associated with the monitored data using input interface 102, output interface 104, and/or communication interface 106 so that appropriate action can be initiated in response to changes in the monitored data. For example, if a machine is being monitored and begins to overheat, a warning or alert message may be sent to a user's smartphone or tablet through communication interface 106 so that the machine can be shut down before damage to the machine occurs.

SVDD update application 122 may be implemented as a Web application. For example, SVDD update application 122 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Input dataset 124 may include, for example, a plurality of rows and a plurality of columns. The plurality of rows may be referred to as observation vectors or records (observations), and the columns may be referred to as variables. Input dataset 124 may be transposed. Input dataset 124 may include unsupervised data. The plurality of variables may define multiple dimensions for each observation vector. An observation vector xᵢ may include a value for each of the plurality of variables associated with the observation i. All or a subset of the columns may be used as variables that define observation vector xᵢ. Each variable of the plurality of variables may describe a characteristic of a physical object. For example, if input dataset 124 includes data related to operation of a vehicle, the variables may include an oil pressure, a speed, a gear indicator, a gas tank level, a tire pressure for each tire, an engine temperature, a radiator level, etc. Input dataset 124 may include data captured as a function of time for one or more physical objects.

The data stored in input dataset 124 may be generated by and/or captured from a variety of sources including one or more sensors of the same or different type, one or more computing devices, etc. The data stored in input dataset 124 may be received directly or indirectly from the source and may or may not be pre-processed in some manner. For example, the data may be pre-processed using an event stream processor such as SAS® Event Stream Processing. As used herein, the data may include any type of content represented in any computer-readable format such as binary, alphanumeric, numeric, string, markup language, etc. The data may be organized using delimited fields, such as comma or space separated fields, fixed width fields, using a SAS® dataset, etc. The SAS dataset may be a SAS® file stored in a SAS® library that a SAS® software tool creates and processes. The SAS dataset contains data values that are organized as a table of observations (rows) and variables (columns) that can be processed by one or more SAS software tools.

Input dataset 124 may be stored on computer-readable medium 108 or on one or more computer-readable media of distributed computing system 130 and accessed by SVDD update device 100 using communication interface 106, input interface 102, and/or output interface 104. Data stored in input dataset 124 may be continually received for processing by SVDD update application 122. Data stored in input dataset 124 may be sensor measurements or signal values captured by sensor 115, may be generated or captured in response to occurrence of an event or a transaction, generated by a device such as in response to an interaction by a user with the device, etc. The data stored in input dataset 124 may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. The data stored in input dataset 124 may be captured at different time points periodically, intermittently, when an event occurs, etc. One or more columns of input dataset 124 may include a time and/or date value.

Input dataset 124 may include data captured under normal operating conditions of the physical object. Input dataset 124 may include data captured at a high data rate such as 200 or more observations per second for one or more physical objects. For example, data stored in input dataset 124 may be generated as part of the Internet of Things (IoT), where things (e.g., machines, devices, phones, sensors) can be connected to networks and the data from these things collected and processed within the things and/or external to the things before being stored in input dataset 124. For example, the IoT can include sensors, such as sensor 115, in many different devices and types of devices, and high value analytics can be applied to identify hidden relationships and drive increased efficiencies. This can apply to both big data analytics and real-time analytics. Some of these devices may be referred to as edge devices, and may involve edge computing circuitry. These devices may provide a variety of stored or generated data, such as network data or data specific to the network devices themselves. Some data may be processed with an event stream processing engine (ESPE), which may reside in the cloud or in an edge device before being stored in input dataset 124.

Input dataset 124 may be stored using various data structures as known to those skilled in the art including one or more files of a file system, a relational database, one or more tables of a system of tables, a structured query language database, etc. on SVDD update device 100 or on distributed computing system 130. SVDD update device 100 may coordinate access to input dataset 124 that is distributed across distributed computing system 130 that may include one or more computing devices. For example, input dataset 124 may be stored in a cube distributed across a grid of computers as understood by a person of skill in the art. As another example, input dataset 124 may be stored in a multi-node Hadoop® cluster. For instance, Apache™ Hadoop® is an open-source software framework for distributed computing supported by the Apache Software Foundation. As another example, input dataset 124 may be stored in a cloud of computers and accessed using cloud computing technologies, as understood by a person of skill in the art. The SAS® LASR™ Analytic Server may be used as an analytic platform to enable multiple users to concurrently access data stored in input dataset 124. The SAS® Viya™ open, cloud-ready, in-memory architecture also may be used as an analytic platform to enable multiple users to concurrently access data stored in input dataset 124. Some systems may use SAS In-Memory Statistics for Hadoop® to read big data once and analyze it several times by persisting it in-memory for the entire session. Some systems may be of other types and configurations.

An SVDD algorithm is used in domains where a majority of data in input dataset 124 belongs to a single class. An SVDD algorithm for normal data description builds a minimum radius hypersphere around the data. The SVDD algorithm identifies support vectors and uses them to define a boundary around the data. If a new data point lies outside the boundary, it is classified as an outlier; otherwise, it is classified as normal data. The simplest form of a boundary is a sphere. For a set of data points x₁, x₂, . . . xₙ, the mathematical formulation finds a nonnegative vector that contains Lagrange multipliers for all data points such that the following objective function is maximized:

L=Σᵢ₌₁ⁿαᵢ(xᵢ·xᵢ)−Σᵢ₌₁ⁿΣⱼ₌₁ⁿαᵢα₁(xᵢ·xⱼ), (1)

subject to:

Σᵢ₌₁ⁿαᵢ=1, (2)

0≤αᵢ≤C, ∀i=1, . . . , n, (3)

where xᵢ∈ [symbol] ^{m}, i=1, n represents n observations, αᵢ∈ [symbol] : are the Lagrange multipliers, C=1/nf is a penalty constant that controls a trade-off between a volume and errors, and f is an expected outlier fraction. The expected outlier fraction is generally known to an analyst. For example, in a training phase, C=1 may be used such that none of the n observations are treated as outliers.

Depending upon a position of an observation vector, the following results are true:

Center position:Σᵢ₌₁ⁿαᵢxᵢ=a. (4)

Inside position:∥xᵢ−a∥<R→αᵢ=0. (5)

Boundary position:∥xᵢ−a∥=R→0<αᵢ<C. (6)

Outside position:∥xᵢ−a∥>R→αᵢ=C. (7)

where α is a center of the hypersphere and R is a radius of the hypersphere. SV is the set of support vectors that includes the observation vectors that have C≥αᵢ>0 after solving equation (1) above. SV_{<C} is a subset of the support vectors that includes the observation vectors that have C>αᵢ>0 after solving equation (1) above. The SV_{<C} is a subset of the support vectors located on a boundary of the minimum radius hypersphere defined around the data and are referred to herein as boundary support vectors BV.

The radius of the hypersphere is calculated using:

R²=xₖ·xₖ−2Σᵢ₌₁^{N}^{_{SV}}αᵢ(xᵢ·xₖ)+Σᵢ₌₁^{N}^{_{SV}}Σⱼ₌₁^{N}^{_{SV}}αᵢαⱼ(xᵢ·x₁) (8)

where any xₖ∈BV, xᵢ and xⱼ are the support vectors, αᵢ and αⱼ are the Lagrange multipliers of the associated support vector, and N_{SV} is a number of the support vectors included in the set of support vectors. An observation vector z is indicated as an outlier when dist²(z)>R², where

dist²(z)=(z·z)−2Σᵢ₌₁^{N}^{_{SV}}αᵢ(xᵢ·z)+Σᵢ₌₁^{N}^{_{SV}}Σⱼ₌₁^{N}^{_{SV}}αᵢαⱼ(xᵢ·xⱼ). (9)

When the outlier fraction f is very small, the penalty constant C is very large resulting in few if any observation vectors in input dataset 124 determined to be in the outside position according to equation (7).

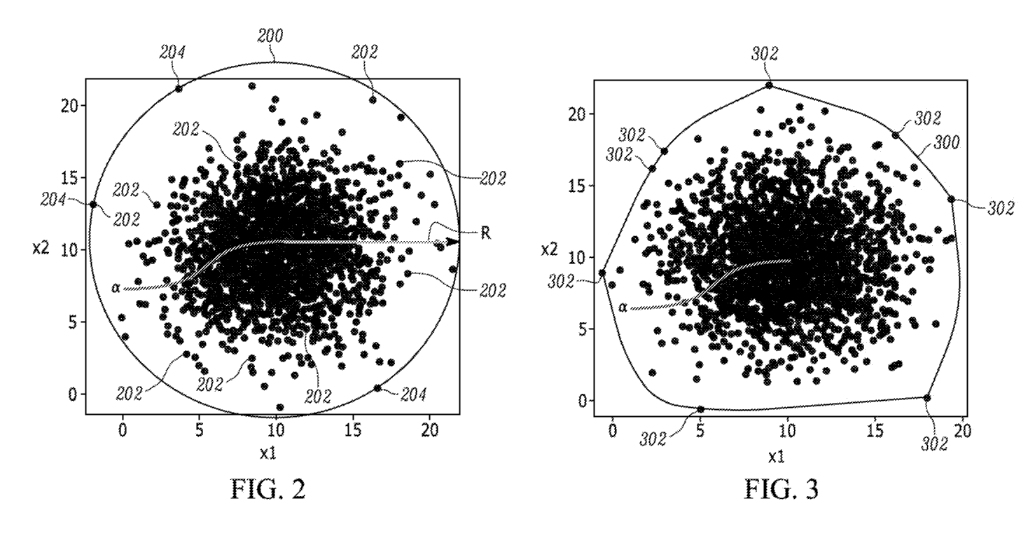

Referring to FIG. 2, an SVDD is illustrated in accordance with an illustrative embodiment that defines a boundary 200 having a radius R from a center a. Boundary 200 is characterized by observation vectors 202 (shown as data points on the graph), which are the set of support vectors SV. For illustration, observation vectors 202 are defined by values of variables x1 and x2 though observation vectors 202 may include a greater number of variables. The subset of observation vectors 204 are the boundary support vectors BV on boundary 200.

Boundary 200 includes a significant amount of space with a very sparse distribution of training observations. Scoring with the model based on the set of support vectors SV that define boundary 200 can increase the probability of false positives. Instead of a circular shape, a compact bounded outline around the data that better approximates a shape of data may be preferred. This is possible using a kernel function. A Gaussian kernel function is used herein. The Gaussian kernel function may be defined as:

$$K ( {x}_{i} , {x}_{j} ) = exp \frac{- {‖ {x}_{i} - {x}_{j} ‖}^{2}}{2 {s}^{2}} \qquad ( 10 )$$

where s is a Gaussian bandwidth parameter.

The objective function for the SVDD model with the Gaussian kernel function is

L=Σᵢ₌₁ⁿαᵢK(xᵢ,xᵢ)−Σᵢ₌₁ⁿΣⱼ₌₁ⁿαᵢαⱼK(xᵢ,xⱼ), (11)

subject to:

Σᵢ₌₁ⁿαᵢ=1, (12)

0≤αᵢ≤C, ∀i=1, . . . , n (13)

where again SV is the set of support vectors that includes the observation vectors that have C≥αᵢ>0 after maximizing equation (11) above. BV are the boundary support vectors that are the subset of the support vectors that have C>αᵢ>0 after solving equation (11) above and are positioned on the boundary.

The results from equations (4) to (7) above remain valid. A threshold R is computed using:

R²=K(xₖ,xₖ)−2Σᵢ₌₁^{N}^{_{SV}}αᵢK(xᵢ,xₖ)+Σᵢ₌₁^{N}^{_{SV}}Σⱼ₌₁^{N}^{_{SV}}αᵢαⱼK(xᵢ,xⱼ) (14)

where any xₖ∈BV, xᵢ and xⱼ are the support vectors, αᵢ and αⱼ are the Lagrange multipliers of the associated support vector, and N_{SV} is a number of the support vectors included in the set of support vectors. For a Gaussian kernel function, K(xₖ,xₖ)=1. Thus, equation (14) can be simplified to R²=1−2Σᵢ₌₁^{N}^{_{SV}}αᵢK(xᵢ,xₖ)+Σᵢ₌₁^{N}^{_{SV}}Σⱼ₌₁^{N}^{_{SV}}αᵢαⱼK(xᵢ,xⱼ) for a Gaussian kernel function.

An observation vector z is indicated as an outlier when dist²(z)>R², where

dist²(z)=K(z,z)−2Σᵢ₌₁^{N}^{_{SV}}αᵢK(xᵢ,z)+Σᵢ₌₁^{N}^{_{SV}}Σⱼ₌₁^{N}^{_{SV}}αᵢαⱼK(xᵢ,xⱼ). (15)

R² is a threshold determined using the set of support vectors. Again, for a Gaussian kernel function, K(z,z)=1. Thus, equation (15) can be simplified to dist²(z)=1−2Σᵢ₌₁^{N}^{_{SV}}αᵢK(xᵢ,z)+Σᵢ₌₁^{N}^{_{SV}}αᵢαⱼK(xᵢ,xⱼ) for a Gaussian kernel function.

Referring to FIG. 3, a second SVDD is shown in accordance with an illustrative embodiment that defines a flexible boundary 300. Boundary support vectors 302 are positioned on flexible boundary 300.

Because ∥α∥₁=1 and α is nonnegative, the objective function can be further simplified to minimizing

$$L = {\sum }_{i = 1}^{n} {\sum }_{j = 1}^{n} {α}_{i} {α}_{j} K ( {x}_{i} , {x}_{j} )$$

which can be expressed in matrix form as

L=α^{T}A₀α

where A₀ is a Gaussian similarity matrix for all data points. Because interior support vectors have αᵢ=0 according to equation (5), they do not contribute to the objective function value. The objective function can be further simplified to

L=α^{T}Aα

where A is a Gaussian similarity matrix for the boundary support vectors BV and α>0 according to equation (6).

Equation (15) can be simplified to

$${dist}^{2} ( z ) = 1 - 2 {\sum }_{i = 1}^{{N}_{BV}} {α}_{i} K ( {x}_{i} , z ) + {\sum }_{i = 1}^{{N}_{BV}} {\sum }_{j = 1}^{{N}_{BV}} {α}_{i} {α}_{j} K ( {x}_{i} , {x}_{j} )$$

where N_{BV} is a number of the boundary support vectors BV and equation (14) can be simplified to

$${R}^{2} = 1 - 2 {\sum }_{i = 1}^{{N}_{BV}} {α}_{i} K ( {x}_{k} , {x}_{i} ) + {\sum }_{i = 1}^{{N}_{BV}} {\sum }_{j = 1}^{{N}_{BV}} {α}_{i} {α}_{j} ( {x}_{i} , {x}_{j} )$$

where dist²(z)=R² for all of the boundary support vectors BV as z though they may have different Lagrange multiplier values.

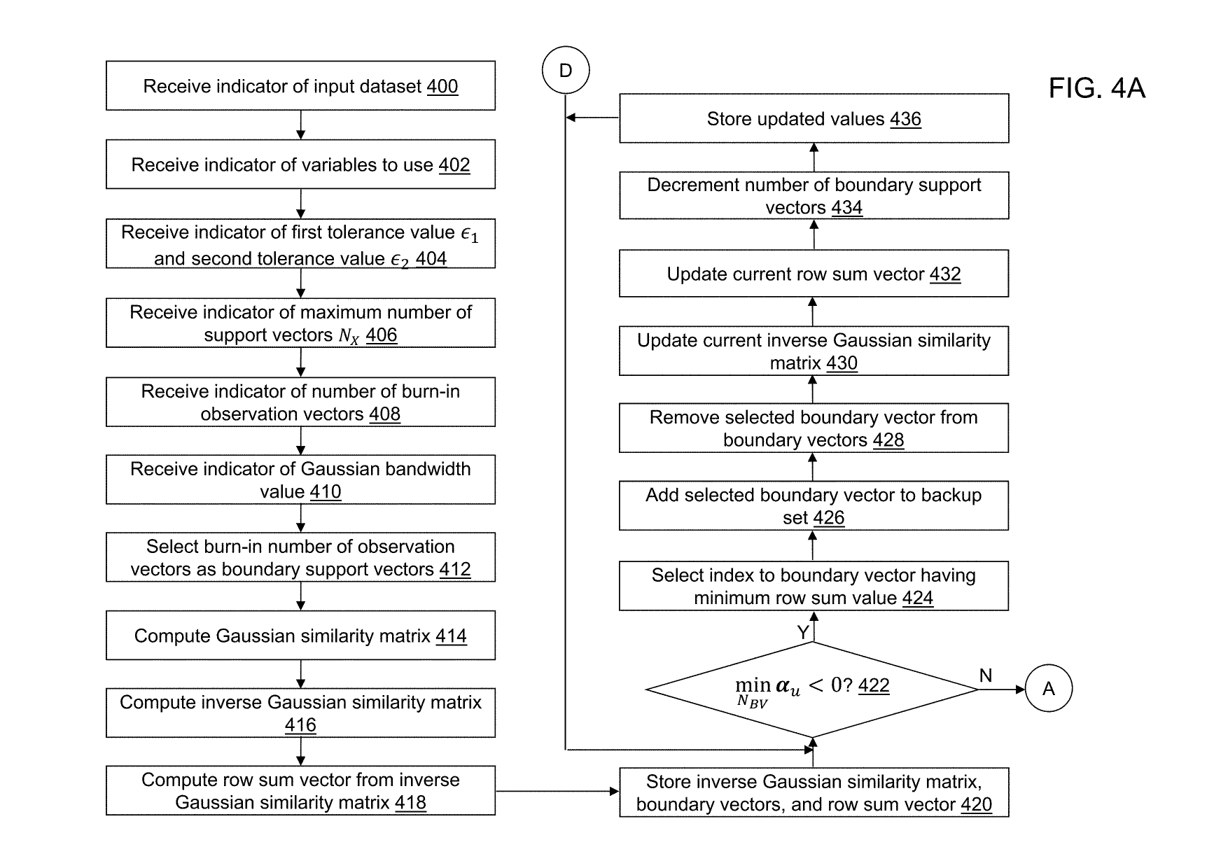

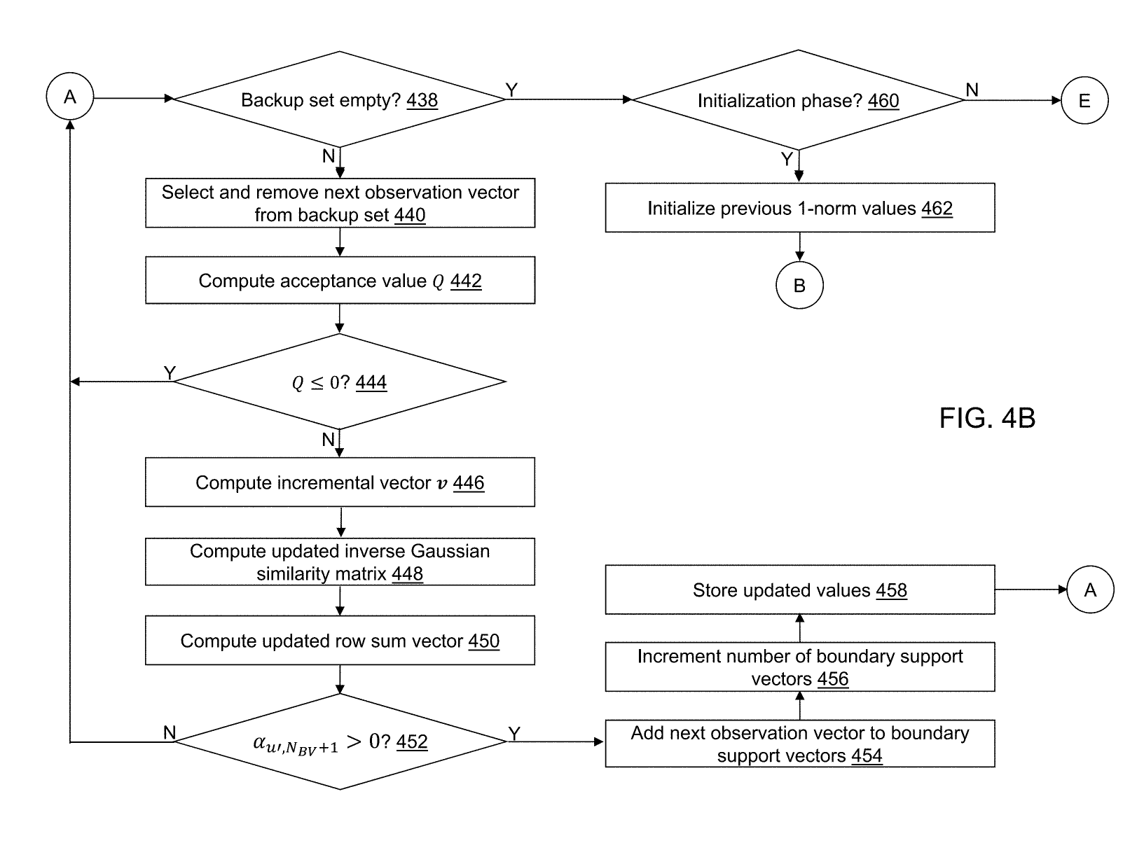

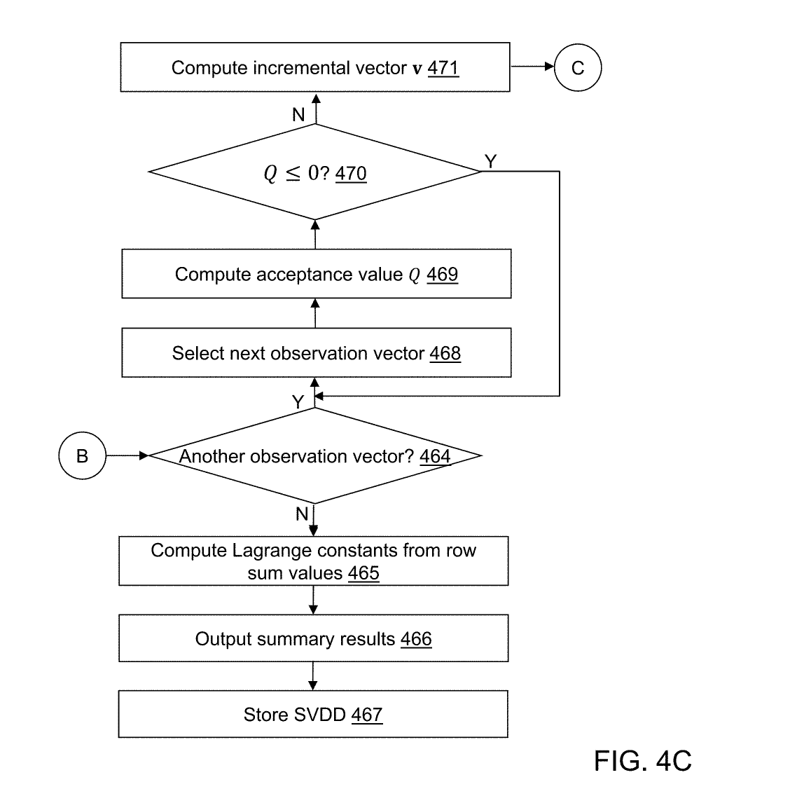

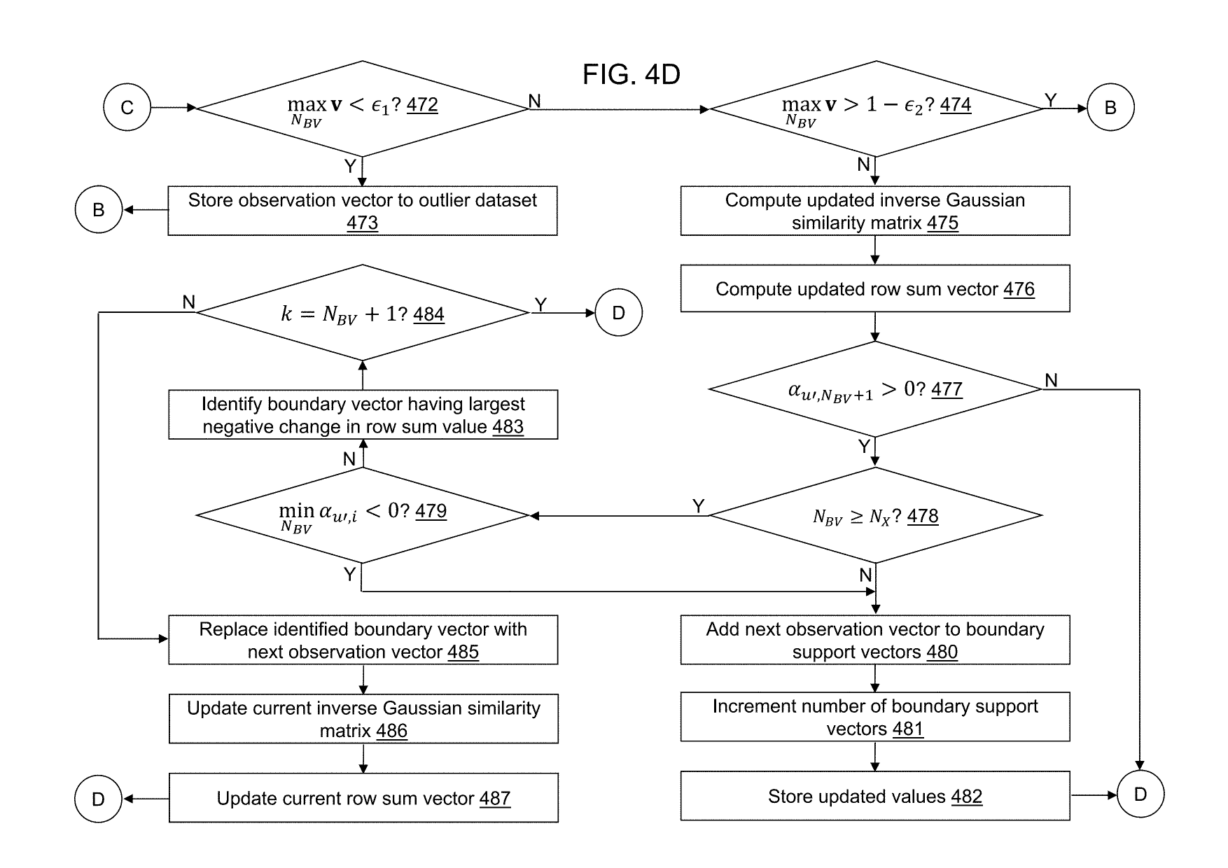

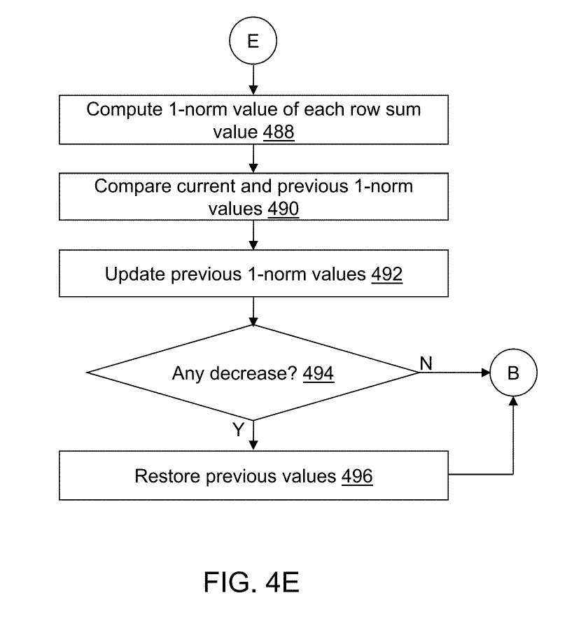

Referring to FIGS. 4A to 4E, example operations associated with SVDD update application 122 are described. Additional, fewer, or different operations may be performed depending on the embodiment of SVDD update application 122. The order of presentation of the operations of FIGS. 4A to 4E is not intended to be limiting. Although some of the operational flows are presented in sequence, the various operations may be performed in various repetitions, concurrently (in parallel, for example, using threads and/or distributed computing system 130), and/or in other orders than those that are illustrated. For example, a user may execute SVDD update application 122, which causes presentation of a first user interface window, which may include a plurality of menus and selectors such as drop-down menus, buttons, text boxes, hyperlinks, etc. associated with SVDD update application 122 as understood by a person of skill in the art. The plurality of menus and selectors may be accessed in various orders. An indicator may indicate one or more user selections from a user interface, one or more data entries into a data field of the user interface, one or more data items read from computer-readable medium 108 or otherwise defined with one or more default values, etc. that are received as an input by SVDD update application 122.

Referring to FIG. 4A, in an operation 400, a first indicator may be received that indicates input dataset 124. For example, the first indicator indicates a location and a name of input dataset 124. As an example, the first indicator may be received by SVDD update application 122 after selection from a user interface window or after entry by a user into a user interface window. In an alternative embodiment, input dataset 124 may not be selectable. For example, a most recently created dataset may be used automatically or input dataset 124 may refer to streaming data as discussed further below.

In an operation 402, a second indicator may be received that indicates a plurality of variables of input dataset 124 to define xᵢ. The second indicator may indicate that all or only a subset of the variables stored in input dataset 124 be used to define SVDD 126. For example, the second indicator indicates a list of variables to use by name, column number, etc. In an alternative embodiment, the second indicator may not be received. For example, all of the variables may be used automatically.

In an operation 404, a third indicator is received that indicates a value for a first tolerance parameter ϵ₁ and for a second tolerance parameter ϵ₂. In an alternative embodiment, the third indicator may not be received or may only indicate a value for one of the first tolerance parameter ϵ₁ or the second tolerance parameter ϵ₂. For example, a default value may be stored for each of the first tolerance parameter ϵ₁ and the second tolerance parameter ϵ₂, or a single value may be stored and used to define both tolerance parameter values in computer-readable medium 108. The stored values may be used automatically. In another alternative embodiment, the value of the first tolerance parameter ϵ₁ may not be selectable. Instead, a fixed, predefined value may be used. For illustration, 1>ϵ₁>0 may be selected from \sqrt{2}×10⁻⁷≤ϵ₁≤\sqrt{2}×10⁻⁵. For further illustration, a value of ϵ₁=10⁻⁶ has been shown to work well. In another alternative embodiment, the value of the second tolerance parameter ϵ₂ may not be selectable. Instead, a fixed, predefined value may be used. For illustration, 1>ϵ₂>0 may be selected from \sqrt{2}×10⁻⁷≤ϵ₂≤\sqrt{2}×10⁻⁵. For further illustration, a value of ϵ₂=10⁻⁶ has been shown to work well.

In an operation 406, a fourth indicator is received that indicates a value for a maximum number of boundary support vectors N_{X}. In an alternative embodiment, the fourth indicator may not be received. For example, a default value may be stored, for example, in computer-readable medium 108 and used automatically. In another alternative embodiment, the value of the maximum number of boundary support vectors N_{X} may not be selectable. Instead, a fixed, predefined value may be used. For example, N_{X}=1000 may be used by default or without allowing a user selection. For illustration, the maximum number of boundary support vectors N_{X} may be selected based on an amount memory available to SVDD update device 100.

In an operation 408, a fifth indicator is received that indicates a value for a number of burn-in observation vectors N_{BI}. In an alternative embodiment, the fifth indicator may not be received. For example, a default value may be stored, for example, in computer-readable medium 108 and used automatically. In another alternative embodiment, the value of the number of burn-in observation vectors N_{BI} may not be selectable. Instead, a fixed, predefined value may be used. For illustration, the number of burn-in observation vectors 100≥N_{BI}≥1 may be used.

In an operation 410, a sixth indicator is received that indicates a value for the Gaussian bandwidth parameters. In an alternative embodiment, the sixth indicator may not be received. For example, a default value may be stored, for example, in computer-readable medium 108 and used automatically. In another alternative embodiment, the value of the Gaussian bandwidth parameter s may not be selectable. Instead, a fixed, predefined value may be used. As another option, the value for the Gaussian bandwidth parameter s may be computed or estimated from one or more observation vectors of input dataset 124. For example, the one or more observation vectors may be the number of burn-in observation vectors N_{BI}. Illustrative methods are described in one or more of U.S. Pat. No. 9,536,208, U.S. Patent Publication No. 2017/0236074, or U.S. patent application Ser. No. 15/887,037, all of which are assigned to the assignee of the present application.

In an operation 412, the number of burn-in observation vectors N_{BI} is selected from input dataset 124 to define a selected set of observation vectors X, where xᵢ∈X, and i=1, . . . , N_{BI}. A set of boundary support vectors BV is initialized with the selected set of observation vectors X. Optionally, the selected set of observation vectors X are used to compute the Gaussian bandwidth parameter s.

In an operation 414, a Gaussian similarity matrix A is computed using

$$A = A ( {x}_{i} , {x}_{j} ) = exp \frac{- {‖ {x}_{i} - {x}_{j} ‖}^{2}}{2 {s}^{2}} , i = 1 , … , {N}_{BV} and j = 1 , … , {N}_{BV} ,$$

where xᵢ and xⱼ are the initialized set of boundary support vectors BV. A is a matrix of length and width defined by the number of boundary support vectors N_{BV}=N_{BI}.

In an operation 416, a current inverse Gaussian similarity matrix A_{N}_{_{BV}}⁻¹ is computed as the inverse of the Gaussian similarity matrix A. A_{N}_{_{BV}}⁻¹ is a matrix of length and width defined by the number of boundary support vectors N_{BV}. There are many methods used to compute an inverse of a square matrix. For illustration, A⁻¹=adj(A)/det(A), where adj(A) is an adjugate of the Gaussian similarity matrix and det(A) is a determinant of the Gaussian similarity matrix. For example, a Gauss-Jordan elimination or a lower upper factorization decomposition method may be used to compute the inverse of the Gaussian similarity matrix A though many other methods exist as understood be a person of skill in the art. When N_{BI}=1, no matrix inverse computation is computed because the current inverse Gaussian similarity matrix A_{N}_{_{BV}}⁻¹ is one.

In an operation 418, a current row sum vector α_{u,N}_{_{BV}} is computed from the current inverse Gaussian similarity matrix A_{N}_{_{BV}}⁻¹. Each value of α_{u,N}_{_{BV}} is a row sum of the associated row of the current inverse Gaussian similarity matrix AV-Bᵥ computed using αᵤ(j)=Σᵢ₌₁^{N}^{_{BV}}A⁻¹(i,j),j=1, N_{BV}. The row sum vector α_{u,N}_{_{BV}} is a vector of length defined by the number of boundary support vectors N_{BV}.

In an operation 420, the current inverse Gaussian similarity matrix A_{N}_{_{BV}}⁻¹, the current row sum vector α_{u,N}_{_{BV}}, and the set of boundary support vectors BV may be stored in SVDD 126 in association with the Gaussian bandwidth parameters s.

In an operation 422, a determination is made concerning whether or not

$${min}_{i} {α}_{{u}^{′} , i} < 0 , i = 1 , … , {N}_{BV} . {min}_{i} {α}_{{u}^{′} , i} < 0$$

vector of the set of boundary support vectors BV is an interior point. When

$${min}_{i} {α}_{{u}^{′} , i} < 0 ,$$

processing continues in an operation 424. When

$${min}_{i} {α}_{{u}^{′} , i} \geq 0 ,$$

processing continues in an operation 438 (shown referring to FIG. 4B).

In operation 424, an index k=i for the boundary vector of the set of boundary support vectors BV having

$${min}_{i} {α}_{{u}^{′} , i} , i = 1 , … , {N}_{BV} ,$$

where 1≤k≤N_{BV} is selected.

In an operation 426, the boundary vector having the selected index k is added to a backup set of vectors.

In an operation 428, the boundary vector having the selected index k is removed from set of boundary support vectors BV.

In operation 430, an updated inverse Gaussian similarity matrix A_{N}_{_{BV}}₋₁⁻¹ is computed to remove the boundary vector having the selected index k. The k^{th} row and column of A_{N}_{_{BV}}₋₁⁻¹ are permuted to the last row and last column of A_{N}_{_{BV}}⁻¹, and A_{N}_{_{BV}}₋₁⁻¹ is computed. For illustration,

$${A}_{{N}_{BV} - 1}^{- 1} = ( \begin{matrix}{P}_{( {N}_{BV} - 1 ) x ( {N}_{BV} - 1 )} & u \\ {u}^{T} & λ\end{matrix} )$$

so that A_{N}_{_{BV}}₋₁⁻¹=P−uu^{T}/λ, and A_{N}_{_{BV}}₋₁⁻¹ is the updated inverse Gaussian similarity matrix.

In an operation 432, an updated row sum vector αᵤ, is computed using the updated inverse Gaussian similarity matrix A_{N}_{_{BV}}₋₁⁻¹.

In an operation 434, the number of boundary support vectors N_{BV} is decremented by one.

In an operation 436, the current inverse Gaussian similarity matrix N_{BV} is replaced with the updated inverse Gaussian similarity matrix A_{N}_{_{BV}}₋₁⁻¹, the current row sum vector αᵤ is replaced with the updated row sum vector α_{u′}, and processing continues in operation 422 to determine if an additional boundary support vector is an interior point that should be removed.

Referring to FIG. 4B, in operation 438, a determination is made concerning whether or not the backup set of vectors is empty. When the backup set of vectors is empty, processing continues in an operation 460. When the backup set of vectors is not empty, processing continues in an operation 440.

In operation 440, a next observation vector z is selected and removed from the backup set of vectors. The observation vectors are removed in first in, first out order so that on a first iteration, the next observation vector is a first vector added in operation 426.

In an operation 442, an acceptance value Q is computed for the next observation vector z selected from the backup set of vectors using

$$Q = ( {dist}^{2} ( z ) - {R}^{2} ) \text{/} 2 = {\sum }_{i = 1}^{{N}_{BV}} {α}_{u , i} K ( {x}_{k} , {x}_{i} ) - {\sum }_{i = 1}^{{N}_{BV}} {α}_{u , i} K ( z , {x}_{i} )$$

where xₖ∈BV, xᵢ is an i^{th} boundary support vector selected from the set of boundary support vectors BV, and α_{u,i} is an i^{th} row sum value selected from the row sum vector αᵤ.

In an operation 444, a determination is made concerning whether or not Q≤0. Q≤0 indicates that the next observation vector z from the backup set of vectors remains an interior point. When Q≤0, processing continues in operation 438 to select a next observation vector from the backup set of vectors. When Q>0, processing continues in an operation 446.

In operation 446, an incremental vector v is computed from the boundary support vectors, where

$${v}_{i} = exp \frac{- {‖ z - {x}_{i} ‖}^{2}}{2 {s}^{2}} , i = 1 , … , {N}_{BV} ,$$

where xᵢ are the set of boundary support vectors BV, and z is the next observation vector.

In an operation 448, an updated inverse Gaussian similarity matrix is computed to include the next observation vector. For illustration,

$${A}_{{N}_{BV} + 1}^{- 1} = ( \begin{matrix}{A}_{{N}_{BV}}^{- 1} + {pp}^{T} \text{/} β & - p \text{/} β \\ - {p}^{T} \text{/} β & 1 \text{/} β\end{matrix} )$$

where p=A_{N}_{_{BV}}⁻¹v and β=1−v^{T}A_{N}_{_{BV}}⁻¹v=1−v^{T}p, A_{N}_{_{BV}}₋₁⁻¹ is the updated inverse Gaussian similarity matrix of the current inverse Gaussian similarity matrix A_{N}_{_{BV}}⁻¹.

In an operation 450, an updated row sum vector αᵤ, is computed using the updated inverse Gaussian similarity matrix A_{N}_{_{BV}}₊₁⁻¹.

In an operation 452, a determination is made concerning whether or not α_{u′,N}_{_{BV+1}}>0. α_{u′,N}_{_{BV+1}}>0 indicates that the next observation vector should be added back to the set of boundary support vectors BV. When α_{u′,N}_{_{BV+1}}>0, processing continues in an operation 454. When α_{u′,N}_{_{BV+1}}≤0, processing continues in operation 438 to select a next observation vector from the backup set of vectors, the current inverse Gaussian similarity matrix A_{N}_{_{BV}}⁻¹ is not updated with the updated inverse Gaussian similarity matrix Aₙ_{_{BV}}₊₁⁻¹ and the current row sum vector αᵤ is not updated with the updated row sum vector αᵤ.

In operation 454, the next observation vector is added to the set of boundary support vectors BV.

In an operation 456, the number of boundary support vectors N_{BV} is incremented by one.

In an operation 458, the current inverse Gaussian similarity matrix A_{N}_{_{BV}}⁻¹ is replaced with the updated inverse Gaussian similarity matrix A_{N}_{_{BV}}₊₁⁻¹, the current row sum vector αᵤ is replaced with the updated row sum vector α_{u′}, and processing continues in operation 438 to select a next observation vector from the backup set of vectors.

In an operation 460, a determination is made concerning whether or not this is a first iteration of operation 460 such that an initialization phase is being executed. When an initialization phase is being executed, processing continues in an operation 462. When an initialization phase is not being executed, processing continues in an operation 488 shown referring to FIG. 4E.

In operation 462, a previous 1-norm value α_{p,i} is initialized for each boundary vector of the set of boundary support vectors using, α_{p,i}=∥α_{u,i}∥₁, i=1, . . . , N_{BV}, and processing continue in an operation 464.

Referring to FIG. 4C, in operation 464, a determination is made concerning whether or not input dataset 124 includes another observation or another observation vector has been received. When there is another observation vector, processing continues in an operation 468 to select and process a next observation vector. When there is not another observation, processing continues in an operation 465.

In operation 465, Lagrange multipliers αᵢ are computed from the current row sum vector αᵤ using αᵢ=α_{u,1}/∥α_{u,1}∥₁, where αᵢ is an i^{th} Lagrange constant value for the i^{th} boundary support vector, and α_{u,i} is an i^{th} row sum value selected from the row sum vector αᵤ.

In an operation 466, summary results are output. For example, statistical results associated with the number of outliers, the number of observation vectors that were interior points, the number of boundary support vectors, etc. may be stored on one or more devices of distributed computing system 130 and/or on computer-readable medium 108 in a variety of formats as understood by a person of skill in the art. The summary results further may be output to display 116, to printer 120, etc.

In an operation 467, SVDD 126 may be stored and may include the boundary support vectors BV, αᵢ the Lagrange multiplier for each of the boundary support vectors BV, the center position a, and/or R² computed from the boundary support vectors BV, and processing is complete. Any other constants associated with the boundary support vectors BV may be stored. For example, W=Σᵢ₌₁^{N}^{_{BV}}Σⱼ₌₁^{N}^{_{BV}} αᵢαⱼK(xᵢ,xⱼ) may be stored for use in computing dist²(z). Additionally, properties such as the objective function value, the number of support vectors, etc. may be stored to SVDD 126.

In an operation 468, a next observation vector is selected from input dataset 124. The next observation vector is read from input dataset 124 after the selected number of burn-in observation vectors N_{BI}. As another option, the next observation vector may be received in a stream of data.

Similar to operation 442, in an operation 469, an acceptance value Q is computed for the next observation vector using

$$Q = ( {dist}^{2} ( z ) - {R}^{2} ) \text{/} 2 = {\sum }_{i = 1}^{{N}_{BV}} {α}_{u , i} K ( {x}_{k} , {x}_{i} ) - {\sum }_{i = 1}^{{N}_{BV}} {α}_{u , i} K ( z , {x}_{i} )$$

where z is the next observation vector, xₖ∈BV, xᵢ is an i^{th} boundary support vector selected from the set of boundary support vectors BV, and α_{u,i} is an i^{th} row sum value selected from the row sum vector αᵤ.

Similar to operation 444, in an operation 470, a determination is made concerning whether or not Q≤0. Q≤0 indicates that the next observation vector is an interior point. When Q≤0, processing continues in operation 468 to select a next observation vector. No further processing is performed on interior points. When Q>0, processing continues in an operation 471.

Similar to operation 446, in operation 471, an incremental vector v is

$${v}_{i} = exp \frac{- {‖ z - {x}_{i} ‖}^{2}}{2 {s}^{2}} , i = 1 , … , {N}_{BV} ,$$

computed from the boundary support vectors, where where xᵢ are the set of boundary support vectors BV, and z is the next observation vector. Processing continues in an operation 472.

Referring to FIG. 4D, in operation 472, a determination is made concerning whether or not

$${max}_{i} v < {ϵ}_{1} , i = 1 , … , {N}_{BV} \cdot {max}_{i} v < {ϵ}_{1}$$

indicates that the next observation vector is an outlier. When

$${max}_{i} v < {ϵ}_{1}$$

processing continues in an operation 473. When

$${max}_{i} v \geq {ϵ}_{1} ,$$

processing continues in an operation 474.

In operation 473, the next observation vector z and/or an indicator of observation vector z is stored to outlier dataset 128, and processing continues in operation 464. Outlier dataset 128 may be output to display 116, to printer 120, etc. In an illustrative embodiment, an alert message may be sent to another device using communication interface 106, printed on printer 120 or another printer, presented visually on display 116 or another display, presented audibly using speaker 118 or another speaker when an outlier is identified.

In operation 474, a determination is made concerning whether or not

$${max}_{i} v > 1 - {ϵ}_{2} , i = 1 , … , {N}_{BV} \cdot {max}_{i} v > 1 - {ϵ}_{2}$$

indicates that the next observation vector is very close to at least one boundary vector of the set of boundary support vectors BV. No further processing is performed on an observation vector that is too close to an existing observation vector. When

$${max}_{i} v > 1 - {ϵ}_{2} ,$$

processing continues in operation 464. When

$${max}_{i} v \leq {ϵ}_{1} ,$$

processing continues in an operation 475.

In operation 475, an updated inverse Gaussian similarity matrix is computed to include the next observation vector. For illustration,

$${A}_{{N}_{BV} + 1}^{- 1} = ( \begin{matrix}{A}_{{N}_{BV}}^{- 1} + {pp}^{T} \text{/} β & - p \text{/} β \\ - {p}^{T} \text{/} β & 1 \text{/} β\end{matrix} )$$

where p=A_{N}_{_{BV}}⁻¹v and β=1−v^{T}A_{N}_{_{BV}}⁻¹v=1−v^{T}p, A_{N}_{_{BV}}₊₁⁻¹ is the updated inverse Gaussian similarity matrix of the current inverse Gaussian similarity matrix A_{N}_{_{BV}}⁻¹.

In an operation 476, an updated row sum vector αᵤ, is computed using the updated inverse Gaussian similarity matrix A_{N}_{_{BV}}₊₁⁻¹.

In an operation 477, a determination is made concerning whether or not α_{u′,N}_{_{BV+1}}>0. α_{u′,N}_{_{BV+1}}>0 indicates that the next observation vector is a new boundary vector. When α_{u′,N}_{_{BV+1}}>0, processing continues in an operation 478. When α_{u′,N}_{_{BV+1}}≤0, processing continues in operation 422, the current inverse Gaussian similarity matrix A_{N}_{_{BV}}⁻¹ is not updated with the updated inverse Gaussian similarity matrix A_{N}_{_{BV}}₊₁⁻¹ and the current row sum vector αᵤ is not updated with the updated row sum vector α_{u′}.

In operation 478, a determination is made concerning whether or not N_{BV} N_{X}. N_{BV} N_{X} indicates that the maximum number of boundary support vectors will be exceeded when the next observation vector is added to the set of boundary support vectors BV. When N_{BV}≥N_{X}, processing continues in an operation 479. When N_{BV}<N_{X}, processing continues in an operation 480.

In operation 479, a determination is made concerning whether or not

$${min}_{i} {α}_{{u}^{′} , i} < 0 , i = 1 , … , {N}_{BV} \cdot {min}_{i} {α}_{{u}^{′} i} < 0$$

indicates that at least one boundary support vector of the set of boundary support vectors BV is an interior point and will be removed as described further below. When

$${min}_{i} {α}_{{u}^{′} i} < 0 ,$$

processing continues in operation 480. When

$${min}_{i} {α}_{{u}^{′} i} < 0 ,$$

processing continues in an operation 483.

In operation 480, the next observation vector is added to the set of boundary support vectors BV.

In an operation 481, the number of boundary support vectors N_{BV} is incremented by one.

In an operation 482, the current inverse Gaussian similarity matrix A_{N}_{_{BV}}⁻¹ is replaced with the updated inverse Gaussian similarity matrix A_{N}_{_{BV}}₊₁⁻¹, the current row sum vector αᵤ is replaced with the updated row sum vector α_{u′}, and processing continues in operation 422.

In operation 483, a boundary vector of the set of boundary support vectors BV having a largest reduction in row sum value is identified. For example,

$${min}_{i} ( {α}_{{u}^{′} , i} - {α}_{u , i} ) , i = 1 , … , {N}_{BV} + 1$$

is computed for the set of boundary support vectors BV and for the incremental vector v, where α_{u,N}_{_{BV+1}}=0. An index k=i may be selected for the identified boundary vector based on

$${min}_{i} ( {α}_{{u}^{′} , i} - {α}_{u , i} ) , i = 1 , … , {N}_{BV} + 1 , where 1 \leq k \leq {N}_{BV} + 1.$$

In an operation 484, a determination is made concerning whether or not k=N_{BV}+1. k=N_{BV}+1 indicates that the next observation vector has the smallest change in row sum value. When k=N_{BV}+1, processing continues in operation 422, the current inverse Gaussian similarity matrix A_{N}_{_{BV}}⁻¹ is not updated with the updated inverse Gaussian similarity matrix A_{N}_{_{BV}}₊₁⁻¹, and the current row sum vector αᵤ is not updated with the updated row sum vector α_{u′}. When k<N_{BV}+1, processing continues in an operation 485.

In operation 485, the identified boundary vector is replaced in the set of boundary support vectors BV with the next observation vector z.

In an operation 486, the current inverse Gaussian similarity matrix A_{N}_{_{BV}}⁻¹ is updated to replace the k^{th} column with the last column by deleting the identified boundary vector and adding the next observation vector z.

In an operation 487, the current row sum vector αᵤ is recomputed using the current inverse Gaussian similarity matrix A_{N}_{_{BV}}⁻¹ computed in operation 486, and processing continues in operation 422.

Referring to FIG. 4E, in operation 488, a current 1-norm of the row sum value αᵢ is computed for each row sum value of the current row sum vector αᵤ, αᵢ=∥α_{u,i}∥₁, i=1, . . . , N_{BV}.

In an operation 490, the current 1-norm value αᵢ is compared to the previous 1-norm value α_{p,i} for each boundary vector of the set of boundary support vectors BV.

In an operation 492, the previous 1-norm value α_{p,i} for each boundary vector of the set of boundary support vectors BV is replaced with the current 1-norm value αᵢ.

In an operation 494, a determination is made concerning whether or not the current 1-norm value αᵢ decreased for any boundary vector of the set of boundary support vectors BV. When any αᵢ decreased, processing continues in an operation 496. When no αᵢ decreased, processing continues in operation 464.

In operation 496, the current inverse Gaussian similarity matrix A_{N}_{_{BV}}⁻¹ and the current row sum vector αᵤ are replaced with a previous matrix and a previous vector, respectively, the set of boundary support vectors BV is replaced with a previous set of boundary support vectors BV, the current 1-norm value αᵢ is replaced with the previous 1-norm value α_{p,i}, and the number of boundary support vectors N_{BV} is updated based on the previous set of boundary support vectors. Processing continues in operation 464 to process a next observation vector, if any.

For any online (streaming) method, it is important that the processing complexity each step is small and that the memory usage cannot expand out of control. The processing complexity provided by SVDD update application 122 is small because SVDD update application 122 minimizes the objective function in equation (11) by updating the inverse similarity matrix for each observation vector. A key advantage of SVDD update application 122 is that the similarity matrix is directly calculated only at initialization using the burn-in observation vectors. Each subsequent iteration calculates only the similarities between a new observation vector and the existing boundary support vectors. These are used to update the inverse of the Gaussian similarity matrix. After the row sum values of the similarity matrix are computed, a shrinking step (e.g. operations 422 to 436) is used to identify any interior points that are removed from the set of boundary support vectors BV and added to the backup set. The backup set is processed to determine if any of the removed boundary vectors should be added back as a boundary support vector (e.g. operations 438 to 458). When a new observation vector is processed, the acceptance value Q is computed and tested to determine if the new observation vector is an interior point. If so, it is skipped (e.g. operations 464 to 470). If not, the incremental vector v is computed and tested to determine if the observation vector is an outlier or is too close to a current boundary support vector. If so, it is skipped (e.g. operations 471 to 474). If not, the inverse of the Gaussian similarity matrix and the row sum values of the similarity matrix are updated and the new observation vector is added to set of boundary support vectors BV as long as its row sum value is greater than zero. If any row sum value is less than or equal to zero there is at least one interior point in the expanded set and the shrinking step is called.

Only matrix multiplications are used to update the inverse Gaussian similarity matrix after its initial computation, which is much faster to compute using a computer than computing a matrix inverse. The key steps provided by SVDD update application 122 (expanding and shrinking the linear systems) require only O(k²) multiplications each time, where k is the number of boundary support vectors. In addition, results from many experiments show that if a proper Gaussian bandwidth is chosen, k should be far less than a total number of the observation vectors included in input dataset 124. As a result, the processing complexity provided by SVDD update application 122 is small. SVDD update application 122 limits the memory usage by limiting the number of boundary support vectors N_{BV} to a maximum number defined by N_{X} by removing a boundary support vector having a smallest change in value for the row sum value.

Computing speed is very important when processing large data or streaming data. In many applications, it can be acceptable to sacrifice some accuracy in exchange for greater efficiency. Instead of pursuing a global optimal solution, SVDD update application 122 obtains the optimal solution each iteration without the interior points. SVDD update application 122 lets the system itself choose which data points to move between the boundary support vector set and interior point sets. The choice may not always optimal, but the backup set allows the system correct itself while removing a significant number of computations. In summary, SVDD update application 122 is fast and computationally efficient because SVDD update application 122 ignores interior points and solely uses matrix manipulations.

When multiple data points are input to SVDD update application 122, a generalized version can be used to expand the system:

$${A}_{{N}_{BV} + 1}^{- 1} = ( \begin{matrix}{A}_{{N}_{BV}}^{- 1} + {PS}^{- 1} {P}^{T} & - {PS}^{- 1} \\ - {S}^{- 1} {P}^{T} & {S}^{- 1}\end{matrix} )$$

where P=A_{N}_{_{BV}}⁻¹ V and S=C−V^{T}A_{N}_{_{BV}}⁻¹V=C−V^{T}P, and C is a Gaussian similarity matrix used when multiple data points are provided at the same time. C uses the same Gaussian bandwidth value.

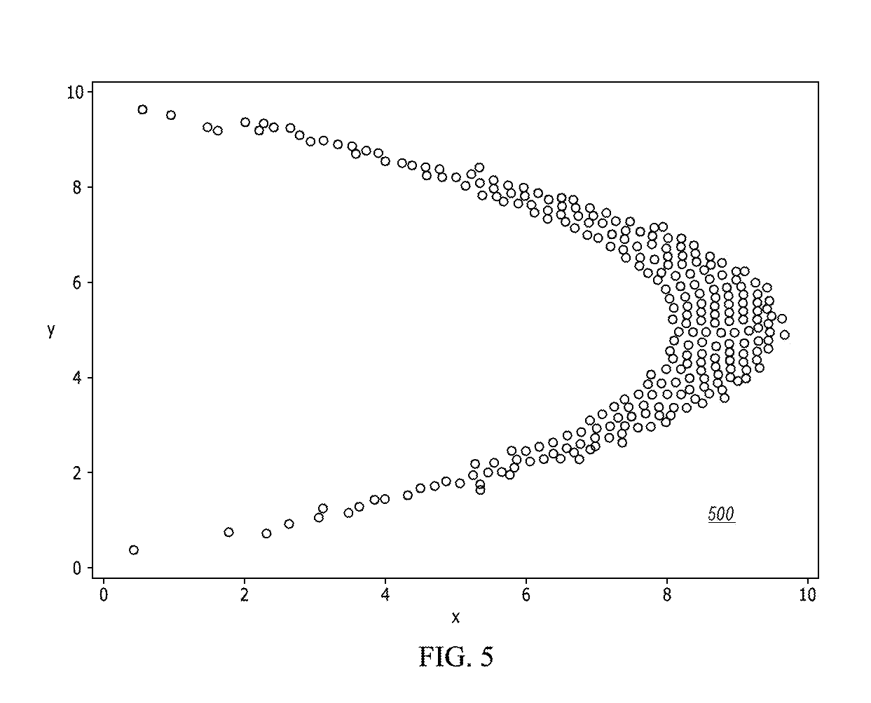

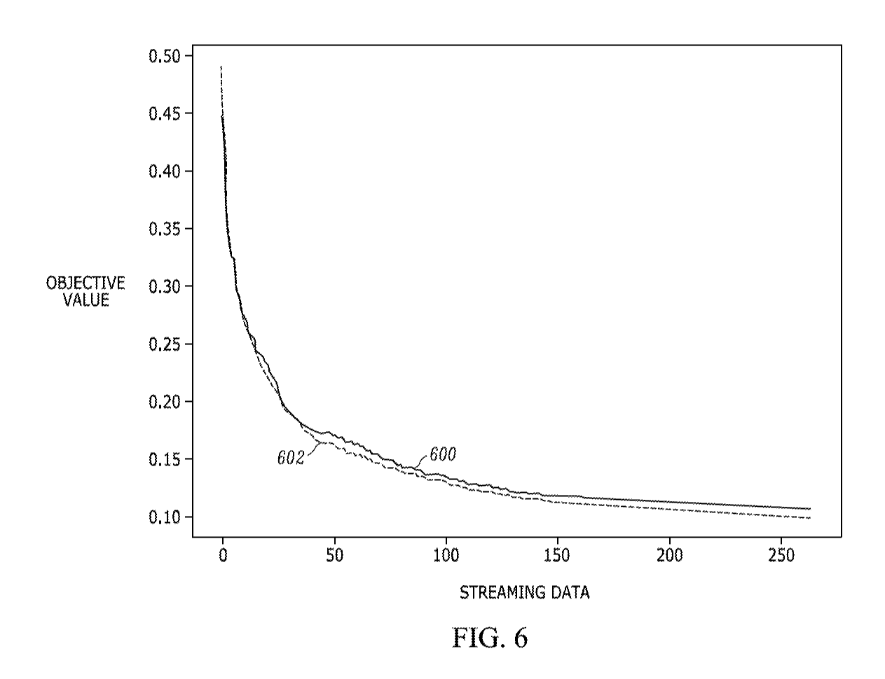

Referring to FIG. 5, a first sample dataset 500 having a banana shape is shown. Referring to FIG. 6, a first optimal objective function value curve 600 provides results computed using SVDD update application 122 with input dataset 124 created from first sample dataset 500. A second optimal objective function value curve 602 provides results computed using a one-class classification version of an SVM algorithm with input dataset 124 created from first sample dataset 500. The SVM algorithm was introduced in a paper by Pavel Laskov et al., titled Incremental support vector learning: Analysis, implementation and applications, published in the Journal of Machine Learning Research, volume 7 at pages 1909-1936 in September of 2006. Both SVDD update application 122 and the SVM algorithm were implemented using SAS/IML® software offered by SAS Institute Inc. of Cary, N.C., USA to calculate the optimal objective function values and determine the computation times for comparison.

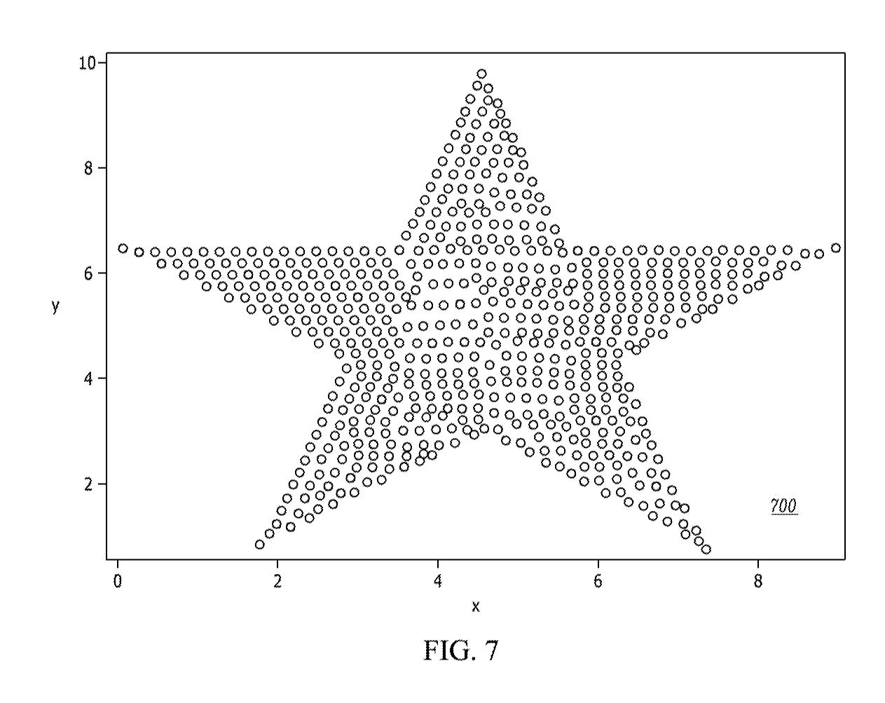

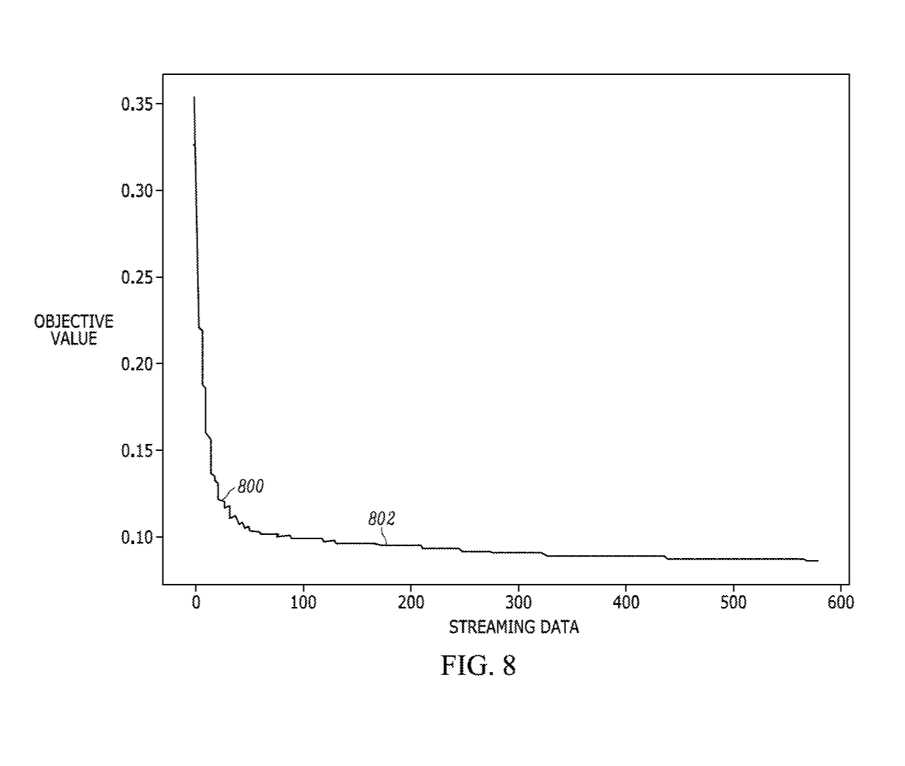

Referring to FIG. 7, a second sample dataset 700 having a star shape is shown. Referring to FIG. 8, a third optimal objective function value curve 800 provides results computed using SVDD update application 122 with input dataset 124 created from second sample dataset 700. A fourth optimal objective function value curve 702 provides results computed using the one-class classification version of the SVM algorithm with input dataset 124 created from second sample dataset 700.

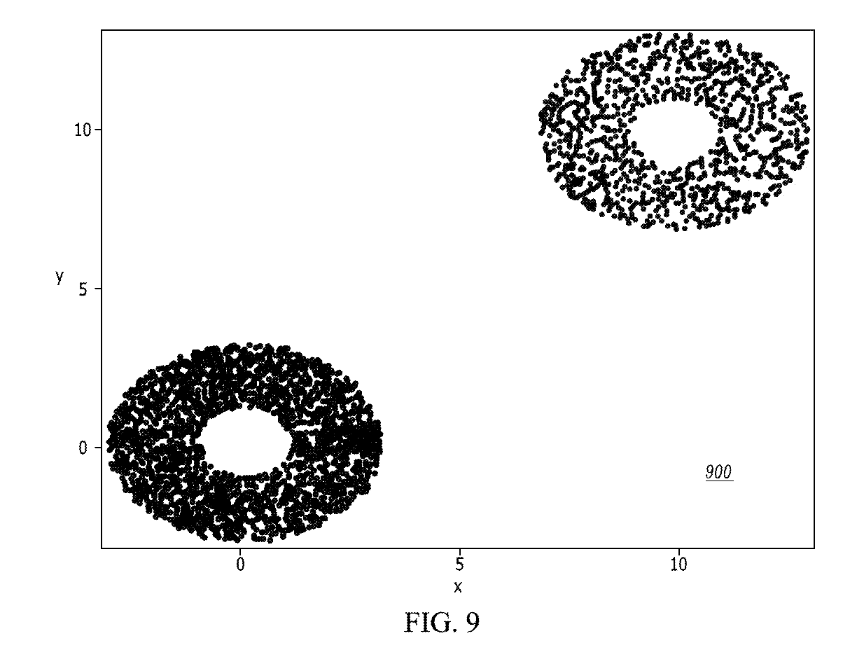

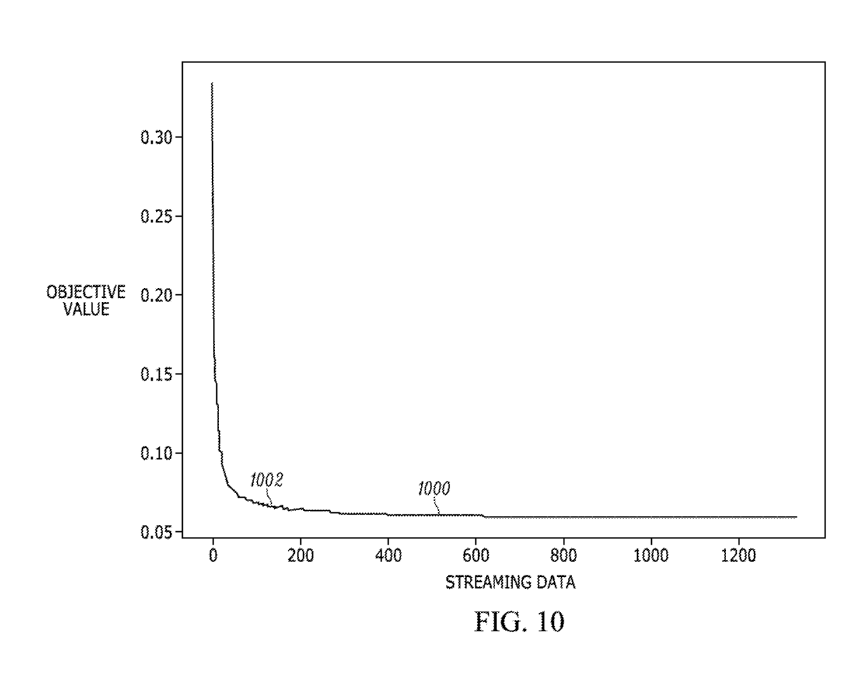

Referring to FIG. 9, a third sample dataset 900 having a two-doughnut shape is shown. Referring to FIG. 10, a fifth optimal objective function value curve 1000 provides results computed using SVDD update application 122 with input dataset 124 created from third sample dataset 900. A sixth optimal objective function value curve 1002 provides results computed using the one-class classification version of the SVM algorithm with input dataset 124 created from third sample dataset 900.

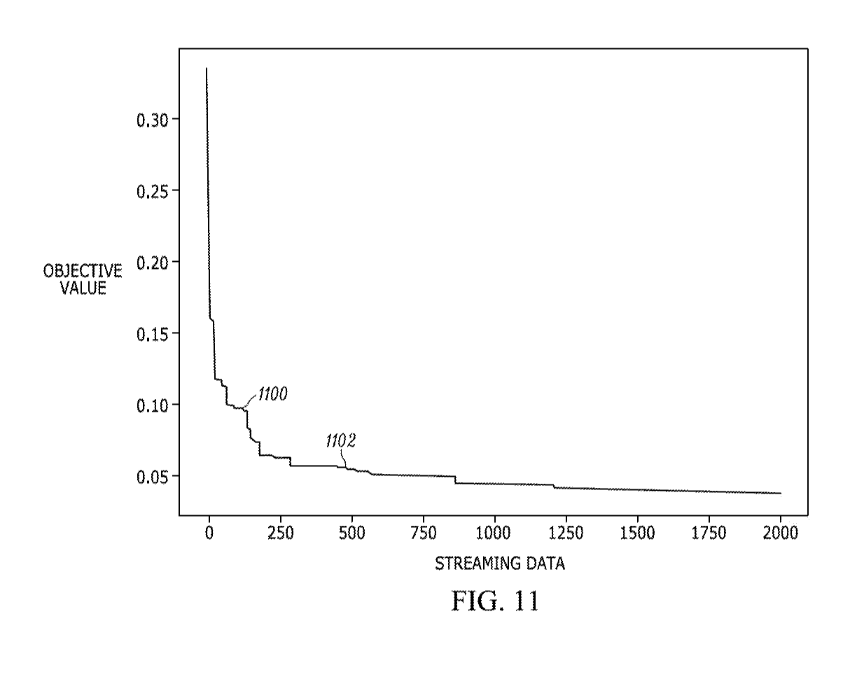

Referring to FIG. 11, a seventh optimal objective function value curve 1100 provides results computed using SVDD update application 122 with input dataset 124 created from a fourth sample dataset. An eighth optimal objective function value curve 1102 provides results computed using the one-class classification version of the SVM algorithm with input dataset 124 created from the fourth sample dataset.

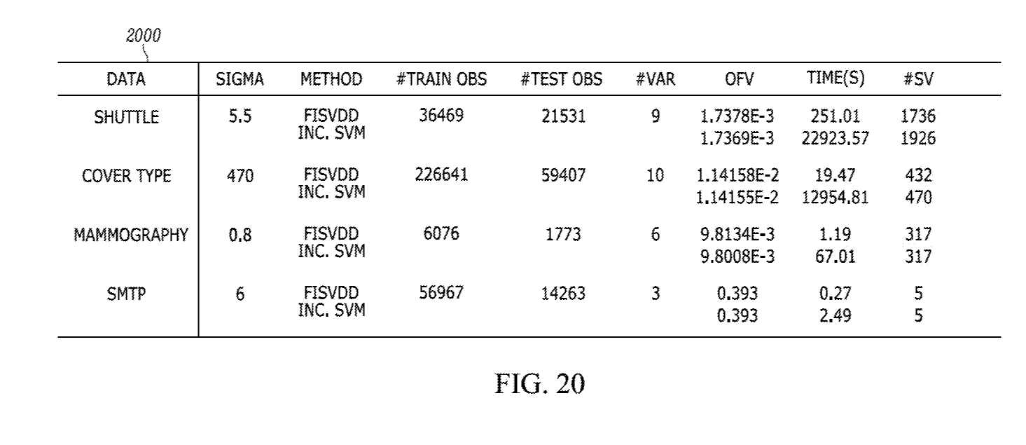

For further comparison, experimental results are shown in FIG. 20 for four different datasets listed in column one of table 2000. A first row of column one of table 2000 indicates the “Shuttle” dataset that is the fourth sample dataset. A second row of column one of table 2000 indicates the “CoverType” dataset that is a fifth sample dataset. A third row of column one of table 2000 indicates the “Mammography” dataset that is a sixth sample dataset. A fourth row of column one of table 2000 indicates the “SMTP” dataset that is a seventh sample dataset. The fourth, fifth, sixth, and seventh sample datasets are publicly available through the UCI machine learning repository cited as Dua, D. and Karra Taniskidou, E., UCI Machine Learning Repository [http://archive.ics.uci.edu/ml], Irvine, Calif.: University of California, School of Information and Computer Science (2017). Column two of table 2000 indicates the Gaussian bandwidth value used for the associated dataset. Column three of table 2000 indicates the method used where FISVDD indicates SVDD update application 122 and “Inc. SVM” indicates the one-class classification version of the SVM algorithm. Column four of table 2000 shows a number of training observation vectors included in the associated dataset. Column five of table 2000 shows a number of test observation vectors included in the associated dataset. Column six of table 2000 shows a number of variables included in the associated dataset. Column seven of table 2000 shows a computed objective function value using the associated dataset and method. Column eight of table 2000 shows a computation time value used to learn the SVDD using the associated dataset and method. Column nine of table 2000 shows a number of support vectors after completion of a training phase using the associated dataset and method. The number of support vectors after completion of the training phase is related to an efficiency of the testing phase. When more support vectors exist, more calculations are required in testing thus requiring a greater computing time.

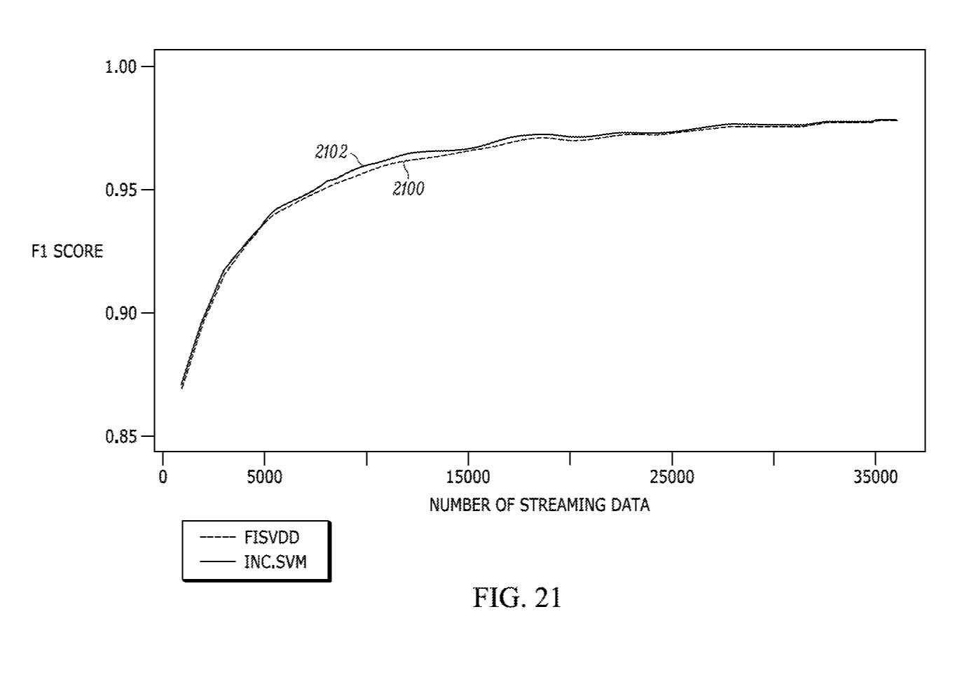

Referring to FIG. 21, a first F-1 accuracy curve 2100 provides an F-1 measure of accuracy computed using SVDD update application 122 with input dataset 124 created from the fourth sample dataset as a function of a number of streamed observation vectors. A second F-1 accuracy curve 2102 provides the F-1 measure of accuracy computed using the one-class classification version of the SVM algorithm with input dataset 124 created from the fourth sample dataset as a function of a number of streamed observation vectors.

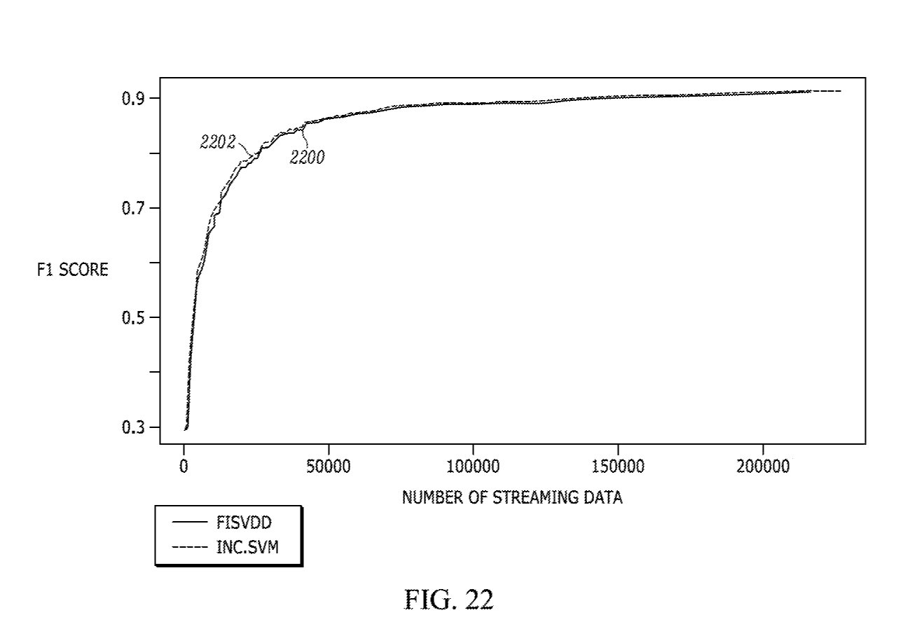

Referring to FIG. 22, a third F-1 accuracy curve 2200 provides an F-1 measure of accuracy computed using SVDD update application 122 with input dataset 124 created from the fifth sample dataset as a function of a number of streamed observation vectors. A fourth F-1 accuracy curve 2202 provides the F-1 measure of accuracy computed using the one-class classification version of the SVM algorithm with input dataset 124 created from the fifth sample dataset as a function of a number of streamed observation vectors.

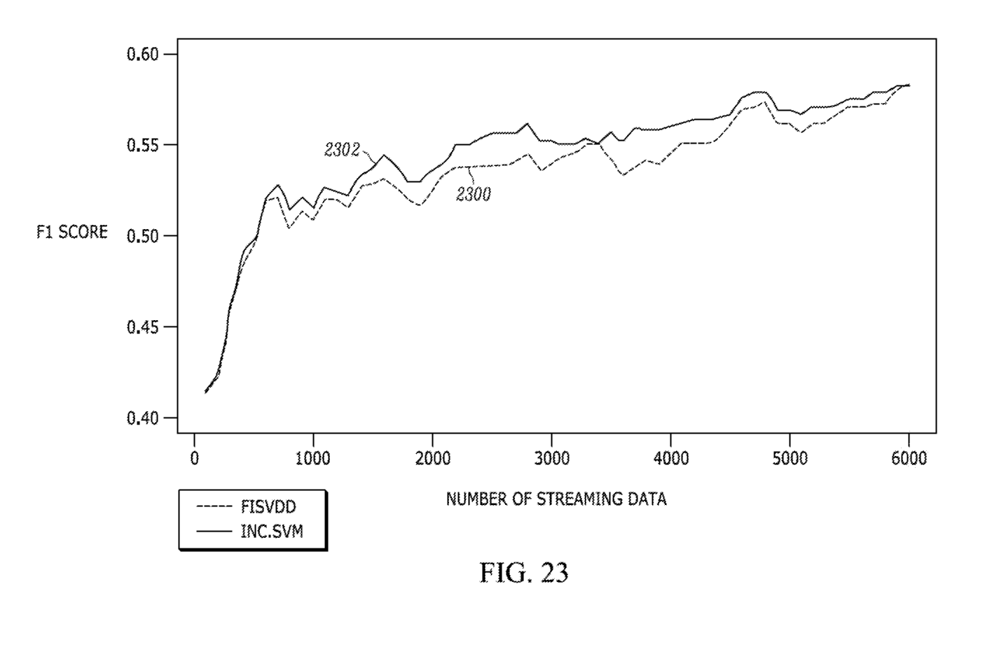

Referring to FIG. 23, a fifth F-1 accuracy curve 2300 provides an F-1 measure of accuracy computed using SVDD update application 122 with input dataset 124 created from the sixth sample dataset as a function of a number of streamed observation vectors. A sixth F-1 accuracy curve 2302 provides the F-1 measure of accuracy computed using the one-class classification version of the SVM algorithm with input dataset 124 created from the sixth sample dataset as a function of a number of streamed observation vectors.

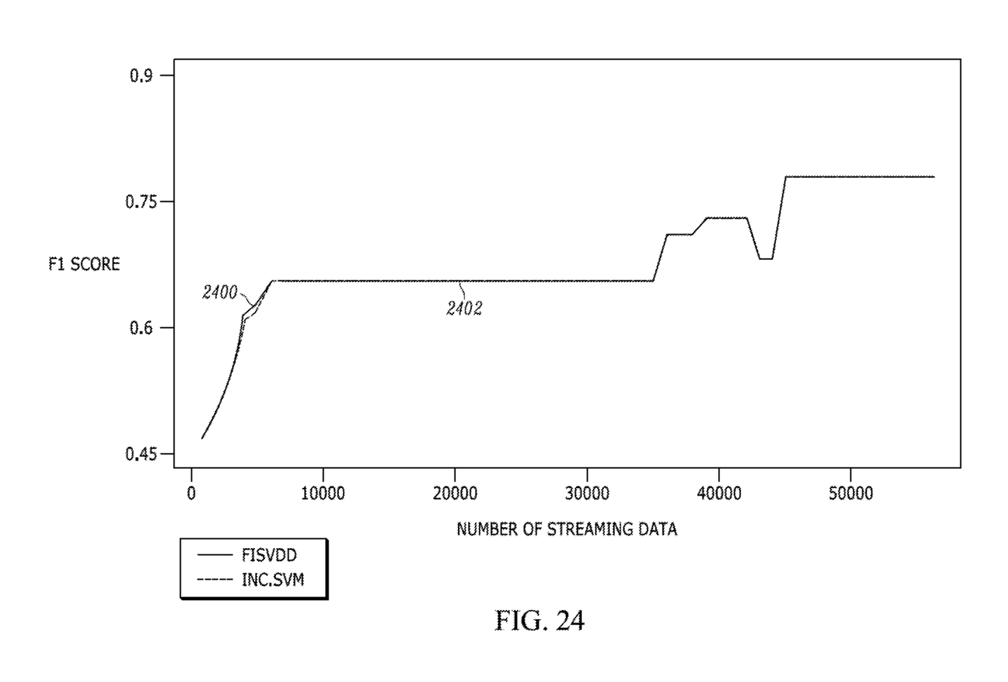

Referring to FIG. 24, a seventh F-1 accuracy curve 2400 provides an F-1 measure of accuracy computed using SVDD update application 122 with input dataset 124 created from the seventh sample dataset as a function of a number of streamed observation vectors. An eighth F-1 accuracy curve 2402 provides the F-1 measure of accuracy computed using the one-class classification version of the SVM algorithm with input dataset 124 created from the seventh sample dataset as a function of a number of streamed observation vectors.

The result of able 2000 and FIGS. 21 to 24 show that for the same Gaussian bandwidth value, SVDD update application 122 is much faster than the one-class classification version of the SVM algorithm with only a tiny sacrifice in the objective function value resulting in almost no loss in the quality of outlier detection. Because the SVM algorithm achieves a global optimal solution, the solutions provided by SVDD update application 122 are very close to the global optimal solution as well.

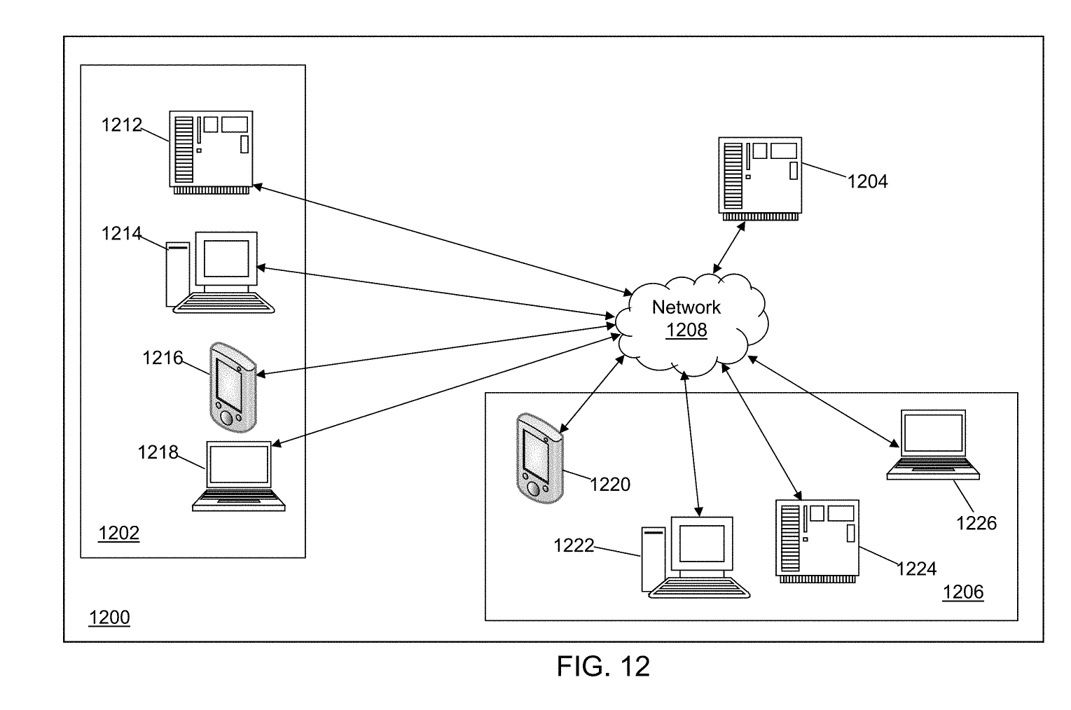

Referring to FIG. 12, a block diagram of a stream processing system 1200 is shown in accordance with an illustrative embodiment. In an illustrative embodiment, stream processing system 1200 may include an event publishing system 1202, an ESP device 1204, an event subscribing system 1206, and a network 1208. Each of event publishing system 1202, ESP device 1204 and event subscribing system 1206 may be composed of one or more discrete devices in communication through network 1208.

Event publishing system 1202 publishes a measurement data value to ESP device 1204 as an “event”. An event is a data record that reflects a state of a system or a device. An event object is stored using a predefined format that includes fields and keys. For illustration, a first field and a second field may represent an operation code (opcode) and a flag. The opcode enables update, upsert, insert, and delete of an event object. The flag indicates whether the measurement data value and/or other field data has all of the fields filled or only updated fields in the case of an “Update” opcode. An “Upsert” opcode updates the event object if a key field already exists; otherwise, the event object is inserted. ESP device 1204 receives the measurement data value in an event stream, processes the measurement data value, and identifies a computing device of event subscribing system 1206 to which the processed measurement data value is sent.

Network 1208 may include one or more networks of the same or different types. Network 1208 can be any type of wired and/or wireless public or private network including a cellular network, a local area network, a wide area network such as the Internet or the World Wide Web, etc. Network 1208 further may comprise sub-networks and consist of any number of communication devices.

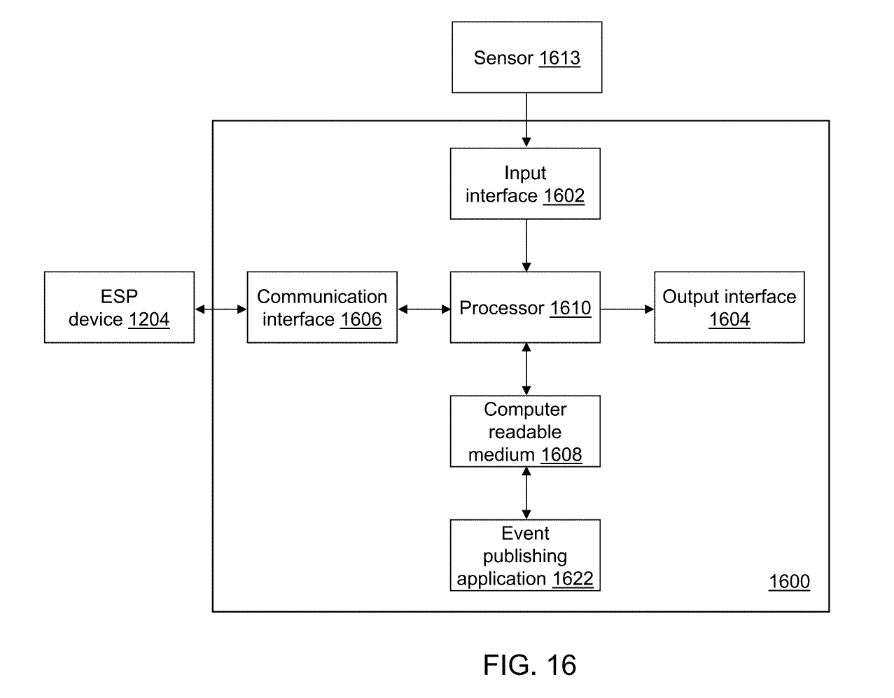

The one or more computing devices of event publishing system 1202 may include computing devices of any form factor such as a server computer 1212, a desktop 1214, a smart phone 1216, a laptop 1218, a personal digital assistant, an integrated messaging device, a tablet computer, a point of sale system, a transaction system, an IoT device, etc. Event publishing system 1202 can include any number and any combination of form factors of computing devices that may be organized into subnets. The computing devices of event publishing system 1202 send and receive signals through network 1208 to/from another of the one or more computing devices of event publishing system 1202 and/or to/from ESP device 1204. The one or more computing devices of event publishing system 1202 may communicate using various transmission media that may be wired and/or wireless as understood by those skilled in the art. The one or more computing devices of event publishing system 1202 may be geographically dispersed from each other and/or co-located. Each computing device of the one or more computing devices of event publishing system 1202 may be executing one or more event publishing applications such as an event publishing application 1622 (shown referring to FIG. 16) of the same or different type.

ESP device 1204 can include any form factor of computing device. For illustration, FIG. 12 represents ESP device 1204 as a server computer. In general, a server computer may include faster processors, additional processors, more disk memory, and/or more RAM than a client computer and support multi-threading as understood by a person of skill in the art. ESP device 1204 sends and receives signals through network 1208 to/from event publishing system 1202 and/or to/from event subscribing system 1206. ESP device 1204 may communicate using various transmission media that may be wired and/or wireless as understood by those skilled in the art. ESP device 1204 may be implemented on a plurality of computing devices of the same or different type that may support failover processing.

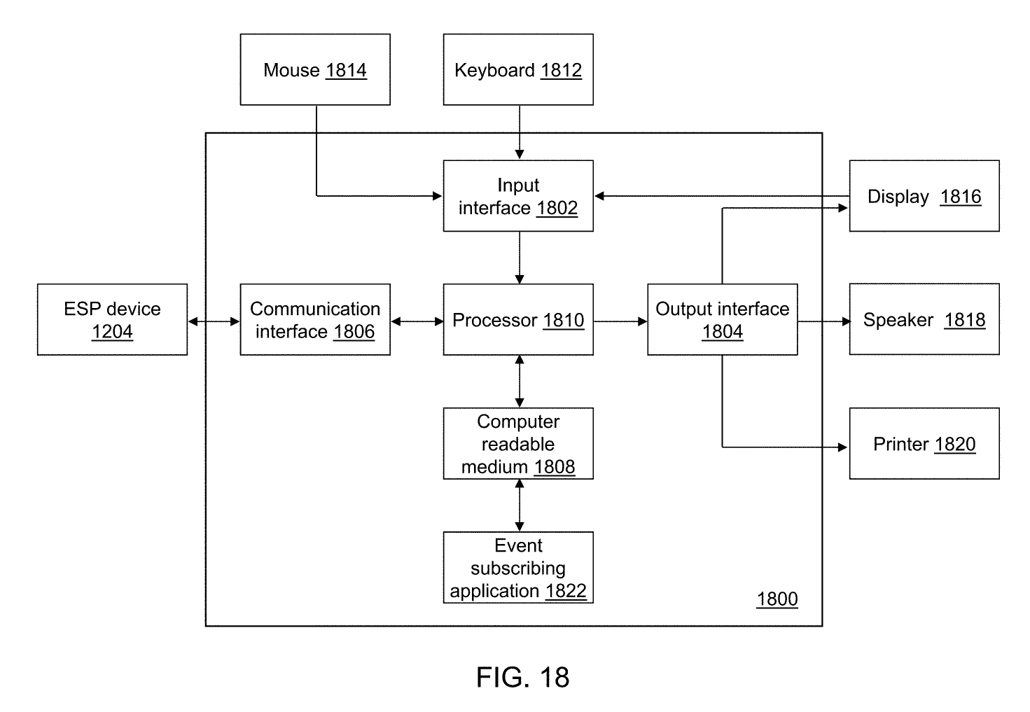

The one or more computing devices of event subscribing system 1206 may include computers of any form factor such as a smart phone 1220, a desktop 1222, a server computer 1224, a laptop 1226, a personal digital assistant, an integrated messaging device, a tablet computer, etc. Event subscribing system 1206 can include any number and any combination of form factors of computing devices. The computing devices of event subscribing system 1206 send and receive signals through network 1208 to/from ESP device 1204. The one or more computing devices of event subscribing system 1206 may be geographically dispersed from each other and/or co-located. The one or more computing devices of event subscribing system 1206 may communicate using various transmission media that may be wired and/or wireless as understood by those skilled in the art. Each computing device of the one or more computing devices of event subscribing system 1206 may be executing one or more event subscribing applications such as an event subscribing application 1822 (shown referring to FIG. 18) of the same or different type.

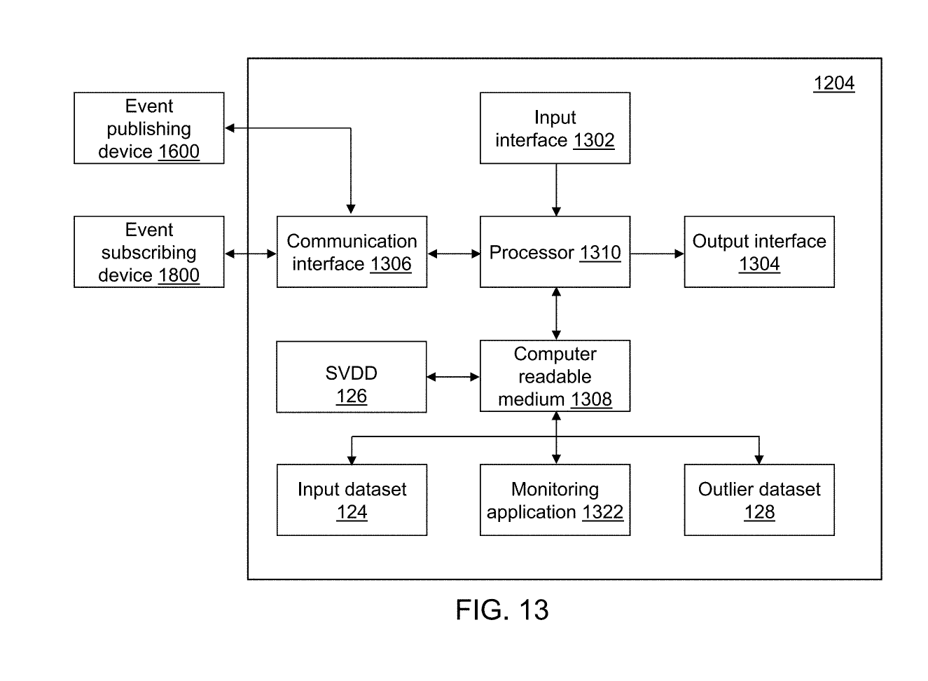

Referring to FIG. 13, a block diagram of ESP device 1204 is shown in accordance with an illustrative embodiment. ESP device 1204 may include a second input interface 1302, a second output interface 1304, a second communication interface 1306, a second non-transitory computer-readable medium 1308, a second processor 1310, monitoring application 1322, input dataset 124, SVDD 126, and outlier dataset 128. Fewer, different, and/or additional components may be incorporated into ESP device 1204. ESP device 1204 and SVDD update device 100 may be the same or different devices.

Second input interface 1302 provides the same or similar functionality as that described with reference to input interface 102 of SVDD update device 100 though referring to ESP device 1204. Second output interface 1304 provides the same or similar functionality as that described with reference to output interface 104 of SVDD update device 100 though referring to ESP device 1204. Second communication interface 1306 provides the same or similar functionality as that described with reference to communication interface 106 of SVDD update device 100 though referring to ESP device 1204. Data and messages may be transferred between ESP device 1204 and distributed computing system 130 using second communication interface 1306. Second computer-readable medium 1308 provides the same or similar functionality as that described with reference to computer-readable medium 108 of SVDD update device 100 though referring to ESP device 1204. Second processor 1310 provides the same or similar functionality as that described with reference to processor 110 of SVDD update device 100 though referring to ESP device 1204.

Monitoring application 1322 performs operations associated with updating SVDD 126 and outlier dataset 128 from data stored in input dataset 124 or received as a new observation vector from an event publishing device 1600 (shown referring to FIG. 16) to identify outliers and to monitor for changes in the data. Monitoring application 1322 may execute all or a subset of the operations of SVDD update application 122. Dependent on the type of data received and/or stored in input dataset 124, outlier dataset 128 may identify anomalies as part of process control, for example, of a manufacturing process, for machine condition monitoring, for example, an electro-cardiogram device, for image classification, for intrusion detection, for fraud detection, etc. Some or all of the operations described herein may be embodied in monitoring application 1322. The operations may be implemented using hardware, firmware, software, or any combination of these methods.

Referring to the example embodiment of FIG. 13, monitoring application 1322 is implemented in software (comprised of computer-readable and/or computer-executable instructions) stored in second computer-readable medium 1308 and accessible by second processor 1310 for execution of the instructions that embody the operations of monitoring application 1322. Monitoring application 1322 may be written using one or more programming languages, assembly languages, scripting languages, etc. Monitoring application 1322 may be integrated with other analytic tools. As an example, monitoring application 1322 may be part of an integrated data analytics software application and/or software architecture such as that offered by SAS Institute Inc. of Cary, N.C., USA. For example, monitoring application 1322 may be part of SAS® Enterprise Miner™ developed and provided by SAS Institute Inc. of Cary, N.C., USA that may be used to create highly accurate predictive and descriptive models based on analysis of vast amounts of data from across an enterprise. Merely for further illustration, monitoring application 1322 may be implemented using or integrated with one or more SAS software tools such as Base SAS, SAS/STATO, SAS® High Performance Analytics Server, SAS® LASR™′ SAS® In-Database Products, SAS® Scalable Performance Data Engine, SAS/ORO, SAS/ETSO, SAS® Inventory Optimization, SAS® Inventory Optimization Workbench, SAS® Visual Analytics, SAS® Viya™, SAS In-Memory Statistics for Hadoop®, SAS® Forecast Server, all of which are developed and provided by SAS Institute Inc. of Cary, N.C., USA. One or more operations of monitoring application 1322 further may be performed by an ESPE. Monitoring application 1322 and SVDD update application 122 further may be integrated applications.

Monitoring application 1322 may be implemented as a Web application. Monitoring application 1322 may be integrated with other system processing tools to automatically process data generated as part of operation of an enterprise, to identify any outliers in the processed data, to monitor the data, and to provide a warning or alert associated with the outlier identification using second input interface 1302, second output interface 1304, and/or second communication interface 1306 so that appropriate action can be initiated in response to the outlier identification. For example, sensor data may be received from event publishing system 1202, processed by monitoring application 1322, and a warning or an alert may be sent to event subscribing system 1206.

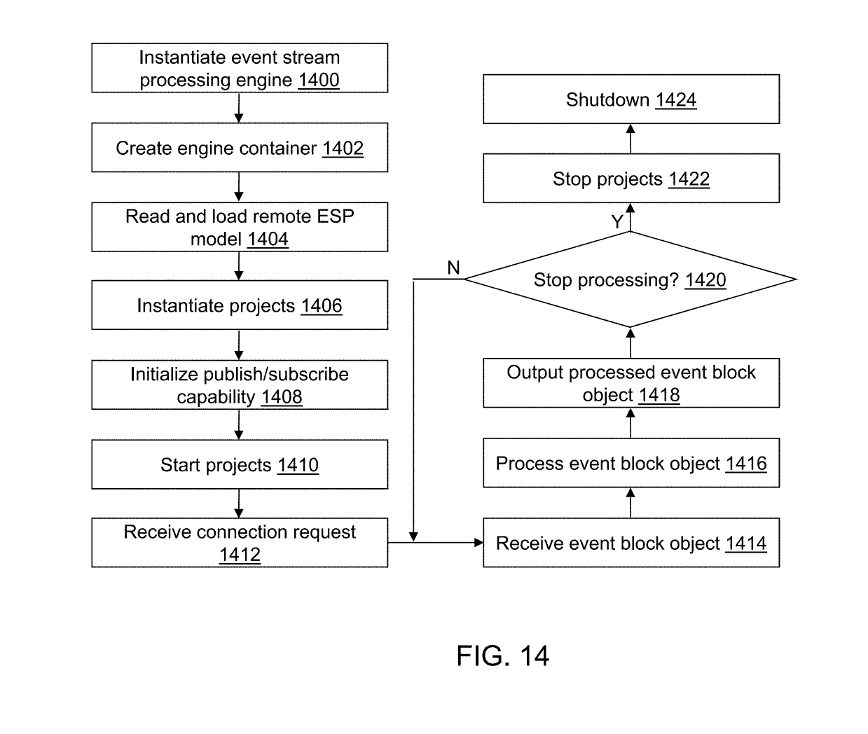

Referring to FIG. 14, a flow diagram illustrating examples of operations performed by ESP device 1204 is shown in accordance with an illustrative embodiment. Additional, fewer, or different operations may be performed depending on the embodiment of monitoring application 1322. The order of presentation of the operations of FIG. 14 is not intended to be limiting. Although some of the operational flows are presented in sequence, the various operations may be performed in various repetitions, concurrently (in parallel, for example, using threads and/or distributed computing system 130), and/or in other orders than those that are illustrated. In an illustrative embodiment, ESP device 1204 is also configured to perform one or more of the operations of FIGS. 4A to 4E. For example, one or more of the indicators and one or more observation vectors in operations 400 to 412 shown referring to FIG. 4A are received from event publishing system 1202. In operation 473 shown referring to FIG. 4D, outlier data may be output to event subscribing system 1206. In operations 466 and 467 shown referring to FIG. 4C, the summary results and/or SVDD 126 may be output to event subscribing system 1206.

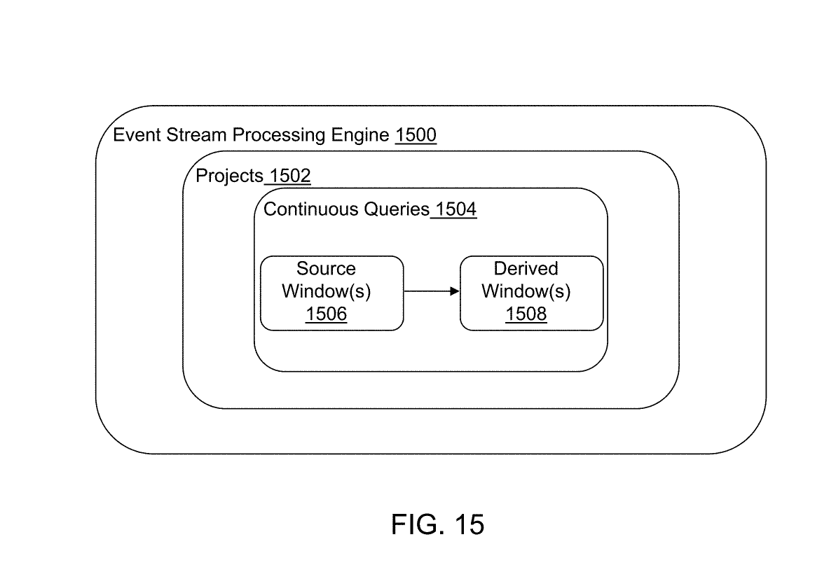

In an operation 1400, an ESP engine (ESPE) 1500 (shown referring to FIG. 15) is instantiated. For example, referring to FIG. 15, the components of ESPE 1500 executing at ESP device 1204 are shown in accordance with an illustrative embodiment. ESPE 1500 may include one or more projects 1502. A project may be described as a second-level container in an engine model managed by ESPE 1500 where a thread pool size for the project may be defined by a user. A value of one for the thread pool size indicates that writes are single-threaded. Each project of the one or more projects 1502 may include one or more continuous queries 1504 that contain data flows, which are data transformations of incoming event streams. The one or more continuous queries 1504 may include one or more source windows 1506 and one or more derived windows 1508.

The engine container is the top-level container in a model that manages the resources of the one or more projects 1502. Each ESPE 1500 has a unique engine name. Additionally, the one or more projects 1502 may each have unique project names, and each query may have a unique continuous query name and begin with a uniquely named source window of the one or more source windows 1506. Each ESPE 1500 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 1506 and the one or more derived windows 1508 represent continuously executing queries that generate updates to a query result set as new event blocks stream through ESPE 1500. A directed graph, for example, is a set of nodes connected by edges, where the edges have a direction associated with them.

An event object may be described as a packet of data accessible as a collection of fields, with at least one of the fields defined as a key or unique identifier (ID). The event object may be an individual record of an event stream. The event object may be created using a variety of formats including binary, alphanumeric, XML, etc. Each event object may include one or more fields designated as a primary ID for the event so ESPE 1500 can support the opcodes for events including insert, update, upsert, and delete. As a result, events entering a source window of the one or more source windows 1506 may be indicated as insert (I), update (U), delete (D), or upsert (P).

For illustration, an event object may be a packed binary representation of one or more sensor measurements and may include both metadata and measurement data associated with a timestamp value. The metadata may include the opcode indicating if the event represents an insert, update, delete, or upsert, a set of flags indicating if the event is a normal, a partial-update, or a retention generated event from retention policy management, and one or more microsecond timestamps. For example, the one or more microsecond timestamps may indicate a sensor data generation time, a data receipt time by event publishing device 1600, a data transmit time by event publishing device 1600, a data receipt time by ESP device 1204, etc.

An event block object may be described as a grouping or package of one or more event objects. An event stream may be described as a flow of event block objects. A continuous query of the one or more continuous queries 1504 transforms the incoming event stream made up of streaming event block objects published into ESPE 1500 into one or more outgoing event streams using the one or more source windows 1506 and the one or more derived windows 1508. A continuous query can also be thought of as data flow modeling. One or more of the operations of FIGS. 4A to 4E may be implemented by the continuous query of the one or more continuous queries 1504.

The one or more source windows 1506 are at the top of the directed graph and have no windows feeding into them. Event streams are published into the one or more source windows 1506 by event publishing system 1206, and from there, the event streams are directed to the next set of connected windows as defined by the directed graph. The one or more derived windows 1508 are all instantiated windows that are not source windows and that have other windows streaming events into them. The one or more derived windows 1508 perform computations or transformations on the incoming event streams. The one or more derived windows 1508 transform event streams based on the window type (that is operators such as join, filter, compute, aggregate, copy, pattern match, procedural, union, etc.) and window settings. As event streams are published into ESPE 1500, they are continuously queried, and the resulting sets of derived windows in these queries are continuously updated.

Referring again to FIG. 14, in an operation 1402, the engine container is created. For illustration, ESPE 1500 may be instantiated using a function call that specifies the engine container as a manager for the model. The function call may include the engine name for ESPE 1500 that may be unique to ESPE 1500.

In an operation 1404, an ESP model that may be stored locally to computer-readable medium 108 is read and loaded.

In an operation 1406, the one or more projects 402 defined by the ESP model are instantiated. Instantiating the one or more projects 1502 also instantiates the one or more continuous queries 1504, the one or more source windows 1506, and the one or more derived windows 1508 defined from the ESP model. Based on the ESP model, ESPE 1500 may analyze and process events in motion or event streams. Instead of storing events and running queries against the stored events, ESPE 1500 may store queries and stream events through them to allow continuous analysis of data as it is received. The one or more source windows 1506 and the one or more derived windows 1508 defined from the ESP model may be created based on the relational, pattern matching, and procedural algorithms that transform the input event streams into the output event streams to model, simulate, score, test, predict, etc. based on the continuous query model defined by the ESP model and event publishing application 1622 that is streaming data to ESPE 1500.

In an operation 1408, the pub/sub capability is initialized for ESPE 1500. In an illustrative embodiment, the pub/sub capability is initialized for each project of the one or more projects 1502. To initialize and enable pub/sub capability for ESPE 1500, a host name and a port number are provided. The host name and the port number of ESPE 1500 may be read from the ESP model. Pub/sub clients can use the host name and the port number of ESP device 1204 to establish pub/sub connections to ESPE 1500. For example, a server listener socket is opened for the port number to enable event publishing system 1202 and/or event subscribing system 1206 to connect to ESPE 1500 for pub/sub services. The host name and the port number of ESP device 1204 to establish pub/sub connections to ESPE 1500 may be referred to as the host:port designation of ESPE 1500 executing on ESP device 1204.

Pub/sub is a message-oriented interaction paradigm based on indirect addressing. Processed data recipients (event subscribing system 1206) specify their interest in receiving information from ESPE 1500 by subscribing to specific classes of events, while information sources (event publishing system 1202) publish events to ESPE 1500 without directly addressing the data recipients.

In an operation 1410, the one or more projects 1502 defined from the ESP model are started. The one or more started projects may run in the background on ESP device 1204.

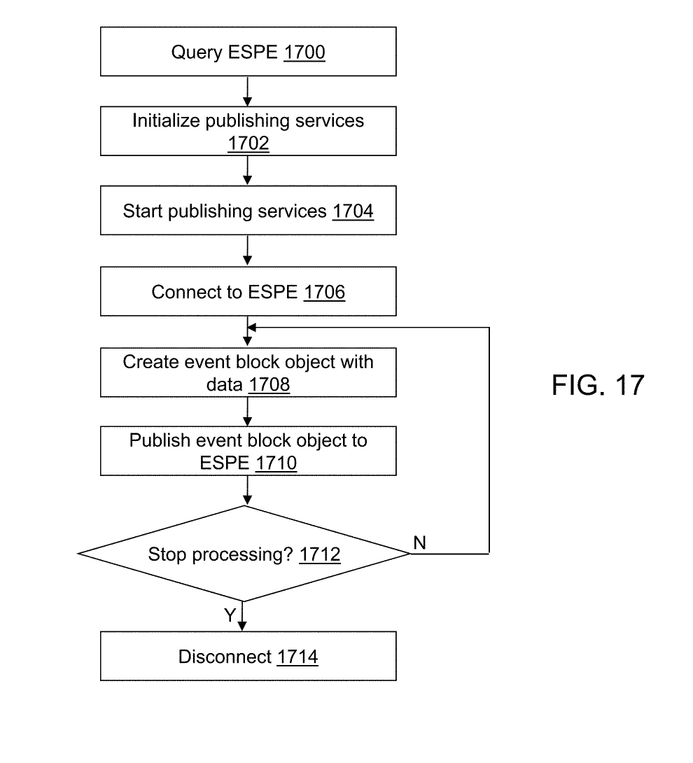

In an operation 1412, a connection request is received from event publishing device 1600 for a source window to which data will be published. A connection request further is received from a computing device of event subscribing system 108, for example, from an event subscribing device 1700 (shown referring to FIG. 17).

In an operation 1414, an event block object is received from event publishing device 1600. An event block object containing one or more event objects is injected into a source window of the one or more source windows 1506 defined from the ESP model. The event block object may include one or more observation vectors.

In an operation 1416, the received event block object is processed through the one or more continuous queries 1504. The unique ID assigned to the event block object by event publishing device 1600 is maintained as the event block object is passed through ESPE 1500 and between the one or more source windows 1506 and/or the one or more derived windows 1508 of ESPE 1500. A unique embedded transaction ID further may be embedded in the event block object as the event block object is processed by a continuous query. ESPE 1500 maintains the event block containership aspect of the received event blocks from when the event block is published into a source window and works its way through the directed graph defined by the one or more continuous queries 1504 with the various event translations before being output to event subscribing device 1700.

For illustration, one or more of the operations of FIGS. 4A to 4E are made available in a calculate window of the continuous queries 1504 of a started project of the projects 1502 of ESPE 1500. The calculate window receives data from the source window, and possibly updates SVDD 126 and possibly identifies an observation vector included in the received event block object as an outlier based on the operations of FIGS. 4A to 4E. Each time a new event block object is received into the calculate window, the appropriate data within the received event block object is extracted and processed. An output from the calculate window may be the updated SVDD 126 or an observation vector identified as an outlier in operation 473.

In an operation 1418, the processed event block object is output to one or more subscribing devices of event subscribing system 108 such as event subscribing device 1700. The processed event block object may only consist of events that include an identified outlier depending on the embodiment. Event subscribing device 1700 can correlate a group of subscribed event block objects back to a group of published event block objects by comparing the unique ID of the event block object that a publisher, such as event publishing device 1600, attached to the event block object with the event block ID received by event subscribing device 1700. The received event block objects further may be stored, for example, in a RAM or cache type memory of computer-readable medium 1308.

In an operation 1420, a determination is made concerning whether or not processing is stopped. If processing is not stopped, processing continues in operation 1414 to continue receiving the one or more event streams containing event block objects from event publishing device 1600. If processing is stopped, processing continues in an operation 1422.

In operation 1422, the started projects are stopped.

In an operation 1424, ESPE 1500 is shutdown.

Referring to FIG. 16, a block diagram of an event publishing device 1600 of event publishing system 1202 is shown in accordance with an example embodiment. Event publishing device 1600 is an example computing device of event publishing system 1202. For example, each of server computer 1212, desktop 1214, smart phone 1216, and laptop 1218 may be an instance of event publishing device 1600. Event publishing device 1600 may include a third input interface 1602, a third output interface 1604, a third communication interface 1606, a third computer-readable medium 1608, a third processor 1610, and event publishing application 1622. Each event publishing device 1600 of event publishing system 1202 may include the same or different components and combinations of components. Fewer, different, and additional components may be incorporated into event publishing device 1600. Event publishing system 1202 includes, is integrated with, and/or communicates with a sensor 1613, data generation devices, data capture devices, etc. For example, sensor 1613 may be the same as or similar to sensor 115.

Third input interface 1602 provides the same or similar functionality as that described with reference to input interface 102 of SVDD update device 100 though referring to event publishing device 1600. Third output interface 1604 provides the same or similar functionality as that described with reference to output interface 104 of SVDD update device 100 though referring to event publishing device 1600. Third communication interface 1606 provides the same or similar functionality as that described with reference to communication interface 106 of SVDD update device 100 though referring to event publishing device 1600. Data and messages may be transferred between event publishing device 1600 and ESP device 1204 using third communication interface 1606. Third computer-readable medium 1608 provides the same or similar functionality as that described with reference to computer-readable medium 108 of SVDD update device 100 though referring to event publishing device 1600. Third processor 1610 provides the same or similar functionality as that described with reference to processor 110 of SVDD update device 100 though referring to event publishing device 1600.

Event publishing application 1622 performs operations associated with generating, capturing, and/or receiving a measurement data value and publishing the measurement data value in an event stream to ESP device 1204. The operations may be implemented using hardware, firmware, software, or any combination of these methods. Referring to the example embodiment of FIG. 16, event publishing application 1622 is implemented in software (comprised of computer-readable and/or computer-executable instructions) stored in third computer-readable medium 1608 and accessible by third processor 1610 for execution of the instructions that embody the operations of event publishing application 1622. Event publishing application 1622 may be written using one or more programming languages, assembly languages, scripting languages, etc. Event publishing application 1622 may be implemented as a Web application.

Referring to FIG. 17, example operations associated with event publishing application 1622 are described. Additional, fewer, or different operations may be performed depending on the embodiment. The order of presentation of the operations of FIG. 17 is not intended to be limiting. A user can interact with one or more user interface windows presented to the user in a display under control of event publishing application 1622 independently or through a browser application in an order selectable by the user. Although some of the operational flows are presented in sequence, the various operations may be performed in various repetitions, concurrently, and/or in other orders than those that are illustrated. For example, a user may execute event publishing application 1622, which causes presentation of a first user interface window, which may include a plurality of menus and selectors such as drop-down menus, buttons, text boxes, hyperlinks, etc. associated with event publishing application 1622 as understood by a person of skill in the art. As further understood by a person of skill in the art, various operations may be performed in parallel, for example, using a plurality of threads or a plurality of computing devices such as a grid or a cloud of computing devices.

In an operation 1600, ESPE 1500 is queried, for example, to discover projects 1502, continuous queries 1504, windows 1506, 1508, window schema, and window edges currently running in ESPE 1500. The engine name and host/port to ESPE 1500 may be provided as an input to the query and a list of strings may be returned with the names of the projects 1502, of the continuous queries 1504, of the windows 1506, 1508, of the window schema, and/or of the window edges of currently running projects on ESPE 1500. The host is associated with a host name or Internet Protocol (IP) address of ESP device 1204. The port is the port number provided when a publish/subscribe (pub/sub) capability is initialized by ESPE 1500. The engine name is the name of ESPE 1500. The engine name of ESPE 1500 and host/port to ESP device 1204 may be read from a storage location on third computer-readable medium 1608, may be provided on a command line, or otherwise input to or defined by event publishing application 1622 as understood by a person of skill in the art.

In an operation 1702, publishing services are initialized.

In an operation 1704, the initialized publishing services are started, which may create a publishing client for the instantiated event publishing application 1622. The publishing client performs the various pub/sub activities for the instantiated event publishing application 1622. For example, a string representation of a URL to ESPE 1500 is passed to a “Start” function. For example, the URL may include the host:port designation of ESPE 1500 executing at ESP device 1204, a project of the projects 1502, a continuous query of the continuous queries 1504, and a window of the source windows 1506. The “Start” function may validate and retain the connection parameters for a specific publishing client connection and return a pointer to the publishing client. For illustration, the URL may be formatted as “dfESP://<host>:<port>/<project name>/<continuous query name>/<source window name>”. If event publishing application 1622 is publishing to more than one source window of ESPE 1500, the initialized publishing services may be started to each source window using the associated names (project name, continuous query name, source window name).

In an operation 1706, a connection is made between event publishing application 1622 and ESPE 1500 for each source window of the source windows 1506 to which any measurement data value is published. To make the connection, the pointer to the created publishing client may be passed to a “Connect” function. If event publishing application 1622 is publishing to more than one source window of ESPE 1500, a connection may be made to each started window using the pointer returned for the respective “Start” function call.

In an operation 1708, an event block object is created by event publishing application 1622 that includes one or more measurement data values. The measurement data values may have been received, captured, generated, etc., for example, through third communication interface 1606 or third input interface 1602 or by third processor 1610. The measurement data values may be processed before inclusion in the event block object, for example, to change a unit of measure, convert to a different reference system, etc. The event block object may include one or more measurement data values measured at different times and/or by different devices.

In an operation 1710, the created event block object is published to ESPE 1500, for example, using the pointer returned for the respective “Start” function call to the appropriate source window. Event publishing application 1622 passes the created event block object to the created publishing client, where the unique ID field in the event block object has been set by event publishing application 1622 possibly after being requested from the created publishing client. In an illustrative embodiment, event publishing application 1622 may wait to begin publishing until a “Ready” callback has been received from the created publishing client. The event block object is injected into the source window, continuous query, and project associated with the started publishing client.

In an operation 1712, a determination is made concerning whether or not processing is stopped. If processing is not stopped, processing continues in operation 1708 to continue creating and publishing event block objects that include measurement data values. If processing is stopped, processing continues in an operation 1714.

In operation 1714, the connection made between event publishing application 1622 and ESPE 1500 through the created publishing client is disconnected, and each started publishing client is stopped.

Referring to FIG. 18, a block diagram of an event subscribing device 1800 is shown in accordance with an example embodiment. Event subscribing device 1800 is an example computing device of event subscribing system 1206. For example, each of smart phone 1220, desktop 1222, server computer 1224, and laptop 1226 may be an instance of event subscribing device 1800. Event subscribing device 1800 may include a fourth input interface 1802, a fourth output interface 1804, a fourth communication interface 1806, a fourth computer-readable medium 1808, a fourth processor 1810, and event subscribing application 1822. Fewer, different, and additional components may be incorporated into event subscribing device 1800. Each event subscribing device 1800 of event subscribing system 1206 may include the same or different components or combination of components.

Fourth input interface 1802 provides the same or similar functionality as that described with reference to input interface 102 of SVDD update device 100 though referring to event subscribing device 1800. Fourth output interface 1804 provides the same or similar functionality as that described with reference to output interface 104 of SVDD update device 100 though referring to event subscribing device 1800. Fourth communication interface 1806 provides the same or similar functionality as that described with reference to communication interface 106 of SVDD update device 100 though referring to event subscribing device 1800. Data and messages may be transferred between event subscribing device 1800 and ESP device 1204 using fourth communication interface 1806. Fourth computer-readable medium 1808 provides the same or similar functionality as that described with reference to computer-readable medium 108 of SVDD update device 100 though referring to event subscribing device 1800. Fourth processor 1810 provides the same or similar functionality as that described with reference to processor 110 of SVDD update device 100 though referring to event subscribing device 1800.

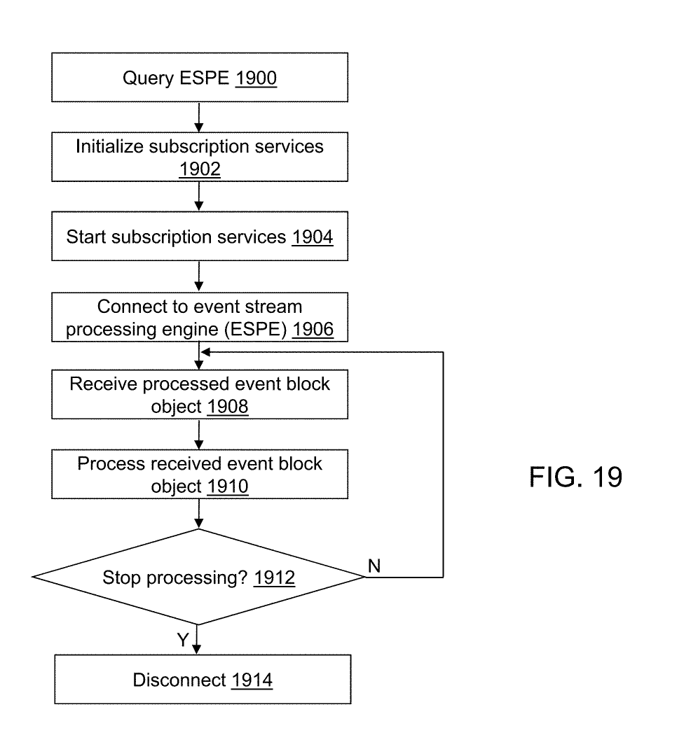

Referring to FIG. 19, example operations associated with event subscribing application 1822 are described. Additional, fewer, or different operations may be performed depending on the embodiment. The order of presentation of the operations of FIG. 19 is not intended to be limiting.

Similar to operation 1700, in an operation 1900, ESPE 1500 is queried, for example, to discover names of projects 1502, of continuous queries 1504, of windows 1506, 1508, of window schema, and of window edges currently running in ESPE 1500. The host name of ESP device 1204, the engine name of ESPE 1500, and the port number opened by ESPE 1500 are provided as an input to the query and a list of strings may be returned with the names to the projects 1502, continuous queries 1504, windows 1506, 1508, window schema, and/or window edges.

In an operation 1902, subscription services are initialized.

In an operation 1904, the initialized subscription services are started, which may create a subscribing client on behalf of event subscribing application 1822 at event subscribing device 1800. The subscribing client performs the various pub/sub activities for event subscribing application 1822. For example, a URL to ESPE 1500 may be passed to a “Start” function. The “Start” function may validate and retain the connection parameters for a specific subscribing client connection and return a pointer to the subscribing client. For illustration, the URL may be formatted as “dfESP://<host>:<port>/<project name>/<continuous query name>/<window name>”.

In an operation 1906, a connection may be made between event subscribing application 1822 executing at event subscribing device 1800 and ESPE 1500 through the created subscribing client. To make the connection, the pointer to the created subscribing client may be passed to a “Connect” function and a mostly non-busy wait loop created to wait for receipt of event block objects.

In an operation 1908, the processed event block object is received by event subscribing application 1822 executing at event subscribing device 1800.

In an operation 1910, the received event block object is processed based on the operational functionality provided by event subscribing application 1822. For example, event subscribing application 1822 may extract data from the received event block object and store the extracted data in a database. In addition, or in the alternative, event subscribing application 1822 may extract data from the received event block object and send the extracted data to a system control operator display system, an automatic control system, a notification device, an analytic device, etc. In addition, or in the alternative, event subscribing application 1822 may extract data from the received event block object and send the extracted data to a post-incident analysis device to further analyze the data. Event subscribing application 1822 may perform any number of different types of actions as a result of extracting data from the received event block object. The action may involve presenting information on a second display 1816 or a second printer 1820, presenting information using a second speaker 1818, storing data in fourth computer-readable medium 1808, sending information to another device using fourth communication interface 1806, etc. A user may further interact with presented information using a second mouse 1814 and/or a second keyboard 1812.

In an operation 1912, a determination is made concerning whether or not processing is stopped. If processing is not stopped, processing continues in operation 1908 to continue receiving and processing event block objects. If processing is stopped, processing continues in an operation 1914.

In operation 1914, the connection made between event subscribing application 1822 and ESPE 1500 through the subscribing client is disconnected, and the subscribing client is stopped.

SVDD update application 122 dynamically updates SVDD 126 and identifies an outlier on batch or streaming data. SVDD update application 122 is very fast, accurate, and uses a very small memory footprint when compared to existing algorithms that compute an SVDD. SVDD update application 122 is fast because it updates SVDD 126 using matrix manipulations to automatically determine the boundary support vectors and discards all interior points after each iteration. A complexity of SVDD update application 122 each iteration is O(k²), where k is a number of boundary support vectors.

SVDD update application 122 is accurate because it computes an optimal solution each iteration so that it provides similar accuracy relative to SVDD computation algorithms that pursue a global optimal solution.

SVDD update application 122 can be implemented as a wrapper code around a core module for SVDD training computations either in a single machine or in a multi-machine distributed environment. SVDD update application 122 further can be implemented as part of a continuous query and executed by ESPE 1500 on streaming data. There are applications for SVDD update application 122 in areas such as process control and equipment health monitoring where the size of input dataset 124 can be very large, consisting of a few million observations. Input dataset 124 may include sensor readings measuring multiple key health or process parameters at a very high frequency. For example, a typical airplane currently has ^{˜}7,000 sensors measuring critical health parameters and creates 2.5 terabytes of data per day. By 2020, this number is expected to triple or quadruple to over 7.5 terabytes. Successful application of a SVDD in these types of applications requires algorithms that can be updated in an efficient manner, which is provided by SVDD update application 122.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

1. A non-transitory computer-readable medium having stored thereon computer-readable instructions that when executed by a computing device cause the computing device to:
compute a Gaussian similarity matrix between a plurality of observation vectors, wherein each observation vector of the plurality of observation vectors includes a variable value for each variable of a plurality of variables;
compute an inverse Gaussian similarity matrix from the computed Gaussian similarity matrix;
compute a row sum vector that includes a row sum value computed from each row of the computed inverse Gaussian similarity matrix;
select a set of boundary support vectors from the plurality of observation vectors;
(a) select a new observation vector from an event stream or from an input dataset;
(b) compute an acceptance value for the selected new observation vector using the selected set of boundary support vectors, the computed row sum vector, and the new observation vector;
(c) when the computed acceptance value is greater than zero, compute an incremental vector from the computed inverse Gaussian similarity matrix and the selected new observation vector;
(d) when the computed acceptance value is greater than zero and when a maximum value of the computed incremental vector is less than a first predefined tolerance value, output an indicator that the selected new observation vector is an abnormal observation vector relative to the selected set of boundary support vectors; and
(e) repeat (a) to (d) until the event stream is stopped or a last observation vector is selected from the input dataset in (a).

2. The non-transitory computer-readable medium of claim 1, wherein the Gaussian similarity matrix is computed using
$$A = exp \frac{- {‖ x ( i ) - x ( j ) ‖}^{2}}{2 {s}^{2}} , i = 1 , … , {N}_{BV} and j = 1 , … , {N}_{BV} ,$$
where x(i) and x(j) are the plurality of observation vectors, s is a Gaussian bandwidth parameter, and N_{BV} is a number of the plurality of observation vectors.

3. The non-transitory computer-readable medium of claim 2, wherein the number of the plurality of observation vectors is a predefined number to initialize the Gaussian similarity matrix.

4. The non-transitory computer-readable medium of claim 3, wherein the predefined number is a predefined subset of an input dataset.

5. The non-transitory computer-readable medium of claim 2, wherein the inverse Gaussian similarity matrix is computed using A⁻¹=adj(A)/det(A), where adj(A) is an adjugate of the Gaussian similarity matrix and det(A) is a determinant of the Gaussian similarity matrix.

6. The non-transitory computer-readable medium of claim 1, wherein the row sum vector is computed using αᵤ(j)=Σᵢ₌₁^{N}^{_{BV}}A⁻¹(i,j), j=1, . . . , N_{BV}, where N_{BV} is a number of the plurality of observation vectors, and A⁻¹(i,j) is the inverse Gaussian similarity matrix.

7. The non-transitory computer-readable medium of claim 6, wherein a Lagrange multiplier for each observation vector is computed using α(k)=αᵤ(k)/∥αᵤ(k)∥₁,k=1, . . . , N_{BV}, where ∥αᵤ(k)∥₁ is a 1-norm of a k^{th} row sum value.

8. The non-transitory computer-readable medium of claim 1, wherein outputting the selected new observation vector as the outlier observation vector comprises presenting the selected new observation vector on a display.

9. The non-transitory computer-readable medium of claim 1, wherein the acceptance value is computed using Q=Σᵢ₌₁^{N}^{_{BV}}αᵤ(i)K(x(k),x(i))−Σᵢ₌₁^{N}^{_{BV}}αᵤ(i)K(z,x(i)), where z is the selected new observation vector, x(k) is any vector of the selected set of boundary support vectors, x(i) is an i^{th} vector of the selected set of boundary support vectors, αᵤ(i) is an i^{th} row sum value selected from the computed row sum vector, N_{BV} is a number of the selected set of boundary support vectors, and K(x(k),x(i)) and K(z,x(i)) are a Gaussian kernel function.

10. The non-transitory computer-readable medium of claim 1, wherein outputting the selected new observation vector as the outlier observation vector comprises sending a message to a second computing device.

11. The non-transitory computer-readable medium of claim 10, wherein the message indicates that a system fault has occurred or that a system state has shifted.

12. The non-transitory computer-readable medium of claim 1, wherein the incremental vector is computed using
$$v ( i ) = exp \frac{- {‖ z - x ( i ) ‖}^{2}}{2 {s}^{2}} , i = 1 , … , {N}_{BV} ,$$
where z is the selected new observation vector, x(i) is an i^{th} vector of the selected set of boundary support vectors, s is a Gaussian bandwidth parameter, and N_{BV} is a number of the selected set of boundary support vectors.

13. The non-transitory computer-readable medium of claim 1, wherein the computer-readable instructions further cause the computing device to repeat (a) to (d) when the maximum value of the computed incremental vector is greater than one minus a second predefined tolerance value.

14. The non-transitory computer-readable medium of claim 13, wherein the second predefined tolerance value is selected between \sqrt{2}×10⁻⁷≤ϵ₂≤\sqrt{2}×10⁻⁵.

15. The non-transitory computer-readable medium of claim 13, wherein, when the maximum value of the computed incremental vector is less than or equal to one minus the second predefined tolerance value, the computer-readable instructions further cause the computing device to:
compute an updated inverse Gaussian similarity matrix from the computed inverse Gaussian similarity matrix using the computed incremental vector;
compute an updated row sum vector that includes the row sum value computed from each row of the computed, updated inverse Gaussian similarity matrix; and
when αᵤ(i)>0, add the selected new observation vector to the set of boundary support vectors, wherein αᵤ(i) is an i^{th} row sum value selected from the computed, updated row sum vector, wherein the i^{th} row sum value is associated with the computed incremental vector.

16. The non-transitory computer-readable medium of claim 15, wherein, before adding the selected new observation vector to the set of boundary support vectors, the computer-readable instructions further cause the computing device to:
compare a number of the selected set of boundary support vectors to a predefined maximum number of support vectors; and
when the number of the selected set of boundary support vectors is greater than or equal to the predefined maximum number of support vectors and αᵤ(i)>0, replace a boundary vector of the set of boundary vectors with the selected new observation vector instead of adding the selected new observation vector to the set of boundary support vectors.

17. The non-transitory computer-readable medium of claim 16, wherein the boundary vector is selected from the set of boundary support vectors based on a reduction value in the row sum value for the boundary vector.

18. The non-transitory computer-readable medium of claim 17, wherein the reduction value for the selected boundary vector is computed using Δαᵤ(k)=α_{u′}(k)−αᵤ(k), where k is an index to the for the boundary vector, α_{u′}(k) is the row sum value for the boundary vector from the computed, updated row sum vector, and αᵤ(k) is the row sum value for the boundary vector from the computed row sum vector.

19. The non-transitory computer-readable medium of claim 17, wherein the selected boundary vector has a largest reduction value relative to any other vector of the set of boundary support vectors.

20. The non-transitory computer-readable medium of claim 1, wherein the set of boundary support vectors are selected from the plurality of observation vectors by removing any interior vectors from the plurality of observation vectors.

21. The non-transitory computer-readable medium of claim 20, wherein an interior vector is identified when αᵤ(i)<0, where αᵤ(i) is an i^{th} row sum value selected from the computed row sum vector.

22. The non-transitory computer-readable medium of claim 21, wherein the row sum vector is computed using αᵤ(j)=Σᵢ₌₁^{N}^{_{BV}}A⁻¹(i,j), j=1, . . . , N_{BV}, where N_{BV} is a number of the plurality of observation vectors, and A⁻¹(i,j) is the inverse Gaussian similarity matrix.

23. The non-transitory computer-readable medium of claim 21, wherein, when the interior vector is identified, the computer-readable instructions further cause the computing device to:
compute an updated inverse Gaussian similarity matrix from the computed inverse Gaussian similarity matrix based on the removed identified interior vector;
compute an updated row sum vector that includes the row sum value computed from each row of the computed, updated inverse Gaussian similarity matrix;
compute a second acceptance value for the removed identified interior vector using the selected set of boundary support vectors, the computed, updated row sum vector, and the removed identified interior vector;
when the computed second acceptance value is greater than zero, compute a second incremental vector from the computed, updated inverse Gaussian similarity matrix and the removed identified interior vector;
compute a second updated inverse Gaussian similarity matrix from the computed, updated inverse Gaussian similarity matrix based on the computed second incremental vector;
compute a second updated row sum vector that includes the row sum value computed from each row of the computed, second updated inverse Gaussian similarity matrix; and
when αᵤ(i)>0, add the removed identified interior vector to the set of boundary support vectors, wherein αᵤ(i) is an i^{th} row sum value selected from the computed, second updated row sum vector, wherein the i^{th} row sum value is associated with the computed second incremental vector.

24. The non-transitory computer-readable medium of claim 1, wherein the plurality of observation vectors is received by the computing device in a stream of event block objects sent from one or more publisher computing devices to the computing device.

25. The non-transitory computer-readable medium of claim 24, wherein a number of the plurality of observation vectors included in the selected set of boundary support vectors is a predefined number of observation vectors received first by the computing device in the stream of event block objects.

26. The non-transitory computer-readable medium of claim 1, wherein the new observation vector is selected from a stream of event block objects received by the computing device from a publisher computing device.

27. The non-transitory computer-readable medium of claim 1, wherein the selected new observation vector is output by streaming the selected new observation vector to a second computing device that subscribes to receive the outlier observation vector.

28. The non-transitory computer-readable medium of claim 1, wherein the computing device is executing an event stream processing engine that performs the computer-readable instructions, wherein the new observation vector was received from a publisher computing device by injecting the new observation vector into a source window of the event stream processing engine, and the outlier observation vector is output to a second computing device that subscribes to receive the outlier observation vector from the event stream processing engine.

29. A computing device comprising:
a processor; and
a non-transitory computer-readable medium operably coupled to the processor, the computer-readable medium having computer-readable instructions stored thereon that, when executed by the processor, cause the computing device to
compute a Gaussian similarity matrix between a plurality of observation vectors, wherein each observation vector of the plurality of observation vectors includes a variable value for each variable of a plurality of variables;
compute an inverse Gaussian similarity matrix from the computed Gaussian similarity matrix;
compute a row sum vector that includes a row sum value computed from each row of the computed inverse Gaussian similarity matrix;
select a set of boundary support vectors from the plurality of observation vectors;
(a) select a new observation vector from an event stream or from an input dataset;
(b) compute an acceptance value for the selected new observation vector using the selected set of boundary support vectors, the computed row sum vector, and the new observation vector;
(c) when the computed acceptance value is greater than zero, compute an incremental vector from the computed inverse Gaussian similarity matrix and the selected new observation vector;
(d) when the computed acceptance value is greater than zero and when a maximum value of the computed incremental vector is less than a first predefined tolerance value, output an indicator that the selected new observation vector is an abnormal observation vector relative to the selected set of boundary support vectors; and
(e) repeat (a) to (d) until the event stream is stopped or a last observation vector is selected from the input dataset in (a).

30. A method of iteratively updating a support vector data description for outlier identification, the method comprising:
computing, by a computing device, a Gaussian similarity matrix between a plurality of observation vectors, wherein each observation vector of the plurality of observation vectors includes a variable value for each variable of a plurality of variables;
computing, by the computing device, an inverse Gaussian similarity matrix from the computed Gaussian similarity matrix;
computing, by the computing device, a row sum vector that includes a row sum value computed from each row of the computed inverse Gaussian similarity matrix;
selecting, by the computing device, a set of boundary support vectors from the plurality of observation vectors;
(a) selecting, by the computing device, a new observation vector from an event stream or from an input dataset;
(b) computing, by the computing device, an acceptance value for the selected new observation vector using the selected set of boundary support vectors, the computed row sum vector, and the new observation vector;
(c) when the computed acceptance value is greater than zero, computing, by the computing device, an incremental vector from the computed inverse Gaussian similarity matrix and the selected new observation vector;
(d) when the computed acceptance value is greater than zero and when a maximum value of the computed incremental vector is less than a first predefined tolerance value, outputting, by the computing device, an indicator that the selected new observation vector is an abnormal observation vector relative to the selected set of boundary support vectors; and
(e) repeating, by the computing device, (a) to (d) until the event stream is stopped or a last observation vector is selected from the input dataset in (a).
